(19) United States
(12) Patent Application Publication
(10) Pub. No.: US 2016/0083570 A1
(43) Pub. Date: Mar. 24, 2016

(54) CELLULAR POLYMERIC MATERIAL

(71) Applicant: Berry Plastics Corporation, Evansville, IN (US)

(72) Inventors: David Dezhou Sun, Evansville, IN (US); John B. Euler, Evansville, IN (US)

(21) Appl. No.: 14/858,193

(22) Filed: Sep. 18, 2015

Related U.S. Application Data
(60) Provisional application No. 62/052,310, filed on Sep. 18, 2014.

(51) Int. Cl. C08L 23/12; B65D 81/38; C08J 9/00

(52) U.S. Cl. CPC C08L 23/12; C08J 9/0061; B65D 81/38; C08L 2205/025; C08J 2323/12; C08J 2423/12

(57) ABSTRACT

A formulation includes a polymeric material, a nucleating agent, and a surface active agent. The formulation may be used to form an insulated container.

### PRIORITY CLAIM

This application claims priority under 35 U.S.C. §119(e) to U.S. Provisional Application Ser. No. 62/052,310, filed Sep. 18, 2014, which is expressly incorporated by reference herein.

### BACKGROUND

The present disclosure relates to polymeric materials that may be formed to produce a container, in particular polymeric materials that insulate. More particularly, the present disclosure relates to morphology and crystalline structure of cellular polymeric material that may be transformed into usable articles, such as insulated containers.

### SUMMARY

An insulated container in accordance with the present disclosure, which may be a drink cup or a food-storage cup (e.g.), is manufactured from a sheet extrudate or tubular extrudate produced in an extrusion process. In illustrative embodiments, the extrudate is a cellular polymeric material.

In illustrative embodiments, an insulative container in accordance with the present disclosure is manufactured from a tubular extrudate produced in an extrusion process. In illustrative embodiments, the extrudate is an insulative cellular polypropylene-based material configured to provide resistance to creasing and/or wrinkling during cup convolution or shaping.

In illustrative embodiments, the cell morphology of an extruded sheet of insulative cellular polypropylene-based material in accordance with the present disclosure is a function of the extrusion angle, which has an effect on the quality of an article, such as an insulative container, formed therewith. In particular, cell morphology is affected by the angle at which a polypropylene-based material in accordance with the present disclosure exits an enclosed die volume through extruder die lips, and is related to a reduction in, if not an elimination of, deep creases and/or wrinkles inside the formed article.

In illustrative embodiments, the cell morphology of an extruded sheet of insulative cellular polypropylene-based material in accordance with the present disclosure is a function of formulation and process conditions, which conditions have an effect on the quality of an article, such as an insulative container, formed therewith. In particular, the effects of such conditions on cell density and cell dimensional attributes, and ultimately on crease/wrinkle resistance, results in a wrinkle-resistance prediction model based on power law regression.

In illustrative embodiments, the cell aspect ratio of insulative cellular polypropylene-based material in accordance with the present disclosure has an effect on the wrinkle resistance of that material during mechanical convolution. Parameters such as cell density and aspect ratio ultimately determine control limits that result in a wrinkle-resistance model for a mechanically convoluted container.

In illustrative embodiments, the circumferential direction cell aspect ratio of an extruded sheet of insulative cellular polypropylene-based material in accordance with the present disclosure has a greater effect than the cell aspect ratio in the axial direction on the wrinkle resistance of that material during mechanical convolution.

In illustrative embodiments, the orientation of an extruded sheet of insulative cellular polypropylene-based material in accordance with the present disclosure has an effect on the wrinkle resistance of that material during mechanical convolution. In particular, when formed into a circular article, the sheet should be oriented such that the circumference of the circular article represents −45° to +45° parallel to the direction of flow for the material of the sheet. The effects of parameters such as sheet orientation in formed circular articles affect the cell morphology of articles, and the cell morphology of the articles ultimately influence their wrinkle-resistance capability.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a perspective view of an insulative cup in accordance with the present disclosure showing that the insulative cup includes a side wall and a floor coupled to the sidewall to define an interior region formed in the insulative cup and that the side wall of the cup extends around the interior region in a circumferential direction (along the circumference of the side wall) and between a brim included in the insulative cup and the floor in an axial directions (up and down);

FIG. 2 is an enlarged view of an axial portion of an insulative cup from the circled region of FIG. 1 showing that the insulative cup is made from an insulative sheet including an outer skin made from a polymeric film and a strip of insulative cellular non-aromatic polymeric material;

FIG. 3 is a diagrammatic and perspective view of a material-forming process in accordance with the present disclosure showing that the material-forming process includes, from left to right, a formulation of insulative cellular non-aromatic polymeric material being placed into a hopper that is fed into a first extrusion zone of a first extruder where heat and pressure are applied to form molten resin and showing that a blowing agent is injected into the molten resin to form an extrusion resin mixture that is fed into a second extrusion zone of a second extruder where the extrusion resin mixture exits and expands to form an extrudate which is slit to form a strip of insulative cellular non-aromatic polymeric material and suggesting that a side-wall blank (in phantom) is oriented on the strip to cause an eventual circumference of an insulative cup formed using the side-wall blank to be oriented in the direction of extrusion;

FIG. 4 is a plan view of a side-wall blank cut from the strip of insulative cellular non-aromatic polymeric material showing the circumferential direction and the axial direction;

FIG. 5 is a microscopy image of an axial portion of an insulative cup made from a 44°-extruded sheet strip from an insulative cellular polypropylene-based material of the present disclosure used to quantify dimensional morphology of cell length and width;

FIG. 6 is a microscopy image of cell wall measurement for a portion of an insulative cup made from a 44°-extruded sheet strip from an insulative cellular polypropylene-based material of the present disclosure used to quantify dimensional morphology;

FIG. 7 is a microscopy image of a portion of an insulative cup made from a 90°-extruded sheet strip from an insulative cellular polypropylene-based material of the present disclosure used to quantify dimensional morphology;

FIG. 8 is an image showing cells with an aspect ratio of about 2.32 and cell density of about 1,216,000 cells/in³, which cells were taken from the axial direction of an insulative cup that demonstrated wrinkle-resistant behavior;

FIG. 9 is an image showing cells with an aspect ratio of about 3.25 and cell density of about 1,159,000 cells/in³, which cells were taken from the axial direction of an insulative cup that demonstrated micro-creasing and macro-creasing behavior;

FIG. 10 is an image showing cells with an aspect ratio of about 1.94 and cell density of about 1,631,000 cells/in³, which cells were taken from the circumferential direction of an insulative cup that demonstrated wrinkle-resistant behavior;

FIG. 11 is an image showing cells with an aspect ratio of about 3.63 and cell density of about 933,000 cells/in³, which cells were taken from the circumferential direction of an insulative cup that demonstrated micro-creasing and macro-creasing behavior;

FIG. 12 is a graph with a power law regression fit of cell density vs. cell length in an x-y plot for insulative cups made from insulative cellular polypropylene-based materials of the present disclosure where the power law equation for predicting cell length with respect to cell density is y=999,162,715.083x⁻²⁶¹³ and R²=0.972;

FIG. 13 is a graph with a power law regression fit of cell density vs. cell length in a log-log plot for the axial directions of insulative cups made from insulative cellular polypropylene-based materials of the present disclosure where the power law equation for predicting cell length with respect to cell density is y=999,162,715.083x⁻²⁶¹³ and R²=0.972;

FIG. 14 is a graph with a power law regression fit of cell density vs. cell width in an x-y plot for the axial directions of insulative cups made from insulative cellular polypropylene-based materials of the present disclosure where the power law equation for predicting cell width with respect to cell density is y=287,106,186.479x^{-3.295} and R²=0.974;

FIG. 15 is a graph with a power law regression fit of cell density vs. cell width in a log-log plot for the axial directions of insulative cups made from insulative cellular polypropylene-based materials of the present disclosure where the power law equation for predicting cell width with respect to cell density is y=287,106,186.479x^{-3.295} and R²=0.974;

FIG. 16 is a graph with a power law regression fit of cell density vs. cell wall thickness in an x-y plot for the axial directions of insulative cups made from insulative cellular polypropylene-based materials of the present disclosure where the power law equation for predicting cell wall thickness with respect to cell density is y=448,002.648x^{-3.053} and R²=0.973;

FIG. 17 is a graph with a power law regression fit of cell density vs. cell wall thickness in a log-log plot for the axial directions of insulative cups made from insulative cellular polypropylene-based materials of the present disclosure where the power law equation for predicting cell wall thickness with respect to cell density is y=448,002.648x^{-3.053} and R²=0.973;

FIG. 18 is a graph with a power law regression fit of cell density vs. cell length in an x-y plot for the axial directions of insulative cups made from insulative cellular polypropylene-based materials of the present disclosure where the power law equation for predicting cell length with respect to cell density is y=1,243,388,528.484x^{-2.626} and R²=0.945;

FIG. 19 is a graph with a power law regression fit of cell density vs. cell width in an x-y plot for the axial directions of insulative cups made from insulative cellular polypropylene-based materials of the present disclosure where the power law equation for predicting cell width with respect to cell density is y=426,736,129.761x^{-3.417} and R²=0.939;

FIG. 20 is an x-y plot of cell density vs. circumferential direction cell aspect ratio illustrating the effect of circumferential direction cell morphology on creasing;

FIG. 21 is an x-y plot of cell density vs. axial direction cell aspect ratio illustrating the effect of axial direction cell morphology on creasing;

FIG. 22 is an elevation view of an extrusion nozzle in accordance with the present disclosure with portions enlarged to show an inner die lip angle X and an outer die lip angle Y;

FIG. 23 illustrates sampling for microscopy and X-Ray analysis for which samples were cut from the side of an insulative cup side wall and analyzed in two perpendicular directions: View A from top to bottom of the cup and view B looking sideways;

FIG. 24 shows a View A microscopy image of the insulative cup side wall from the cup of Example 5 (with printed film laminated to the foam), where OET is outside of the insulative cup, illustrating that the insulative cup side wall collapsed in compression during cup formation leading to crease formation with crease depth of 0.23 mm; and

FIG. 25 shows a View A microscopy image of the insulative cup side wall from an insulative cup that is without a laminated printed film and that a black marker was used to eliminate light reflection for a clearer image, where OET is outside of the insulative cup, again illustrating that creasing/deep wrinkles formed on the inside of the insulative cup in the same way as in FIG. 24.

### DETAILED DESCRIPTION

An unexpected feature of exemplary embodiments of an extruded sheet of insulative cellular polypropylene-based material in accordance with the present disclosure is the ability of the sheet to form a noticeably crease-free and wrinkle-free surface when curved to form a round article, such as an insulative cup. The surface is wrinkle-free even inside the cup, where compression forces typically cause material to crush and/or crease easily, especially for low density material with a large cell aspect ratio. In exemplary embodiments, the surface profile of a cup made from an extruded sheet of insulative cellular polypropylene-based material as detected by microscopy is such that the depth of the indentations (i.e., creases and/or wrinkles) naturally occurring in the outside and inside of the cup surface when it is subject to extension and compression forces during cup forming may be less than about 100 microns. In one exemplary embodiment, the surface profile may include indentations of less than about 50 microns. In another exemplary embodiment, the surface profile may include indentations of about 5 microns or less. At a depth of about 10 microns and less, micro-wrinkles and/or creases on a cup surface are ordinarily not visible to the naked eye.

In one exemplary embodiment, an insulative cup formed from a sheet comprising a skin and a strip of insulative cellular polypropylene-based material in accordance with the present disclosure had typical creases (i.e., deep wrinkles) about 200 microns deep extending from the top of the cup to the bottom of the cup. In another exemplary embodiment, an insulative cup formed from a sheet comprising a strip of insulative cellular polypropylene-based material only (without a skin) in accordance with the present disclosure had typical creases about 200 microns deep extending from the top of the cup to the bottom of the cup. Such creases with depths from about 100 microns to about 500 microns are typically formed inside of a cup undergoing compression. Creases and deep wrinkles may present a problem of unsatisfactory surface quality making cups with such surface features unusable or undesirable. Creases may form in instances where sheets include a skin or exclude a skin.

It was unexpectedly found that the cell morphology of an extruded sheet of insulative cellular polypropylene-based material in accordance with the present disclosure has an effect on the quality of the formed article, such as an insulative cup. The effects of cell morphology on wrinkle resistance in insulative cellular polypropylene-based material may be illustrated through examining the effect of varying the angle of the extruder die lips. In exemplary embodiments, the angle at which insulative cellular polypropylene-based material in accordance with the present disclosure exits an enclosed volume may affect the material's wrinkle resistance. It was found that for a specified formulation of insulative cellular polypropylene-based material and specified cup forming conditions, different die exit angles lead to noticeably different levels of creasing and/or wrinkling in article surfaces during extruded sheet convolution. The two geometric exit angles selected for examination in the present disclosure are those commonly used in polyethylene foam production, i.e., an exit angle of 90°, and in polystyrene foam production, i.e., an exit angle of 44° (see, Example 1).

In exemplary embodiments, insulative cellular polypropylene-based material in accordance with the present disclosure may be extruded as sheet. Microscopy images show that distinct cell morphology exists, i.e., cell structure distinctions, within insulative cups made from such extruded sheets when one sheet is produced with a higher curvature die exit angle and the other with a lower curvature die exit angle. Insulative cups may be made by cutting the sheets such that the resulting circumference of the insulative cup is aligned to be perpendicular or parallel to the direction the sheets are extruded. The difference in cell morphology between cups cut in the two directions may be detected by examining portions cut from the axial sides of the cups under a microscope.

Direct evidence of polymer cell structure is provided by microscopy studies. There is a close relationship between the regularity of molecular structure and malleability. Cell morphology describes polymer cell density, cell structure, cell wall thickness, cell shape, and cell size distribution of cells. Polymer cell structures may have the same general shape and appearance, being composed predominantly of ovular cells, and the same lognormal cell distribution, but possess a different cell aspect ratio and cell wall thickness. Illustratively, cell aspect ratio is the ratio between lengths of the ovular polymer cells to widths of the ovular polymer cells. Illustratively, cell wall thickness is the solid polymeric distance between individual polymer cells.

In one exemplary embodiment, an extruded sheet of insulative cellular polypropylene-based material in accordance with the present disclosure may exit from an enclosed die volume at an angle of 90°. In another exemplary embodiment, an extruded sheet of insulative cellular polypropylene-based material may exit from an enclosed die volume at an angle of 44°. Illustratively, an extruded sheet of insulative cellular polypropylene-based material may exit from an enclosed die volume at an angle between 44° and 90°. Two such sheets, one produced at an exit angle of 44° and the other at an exit angle of 90°, may be prepared as strips either in the machine direction or in the cross direction and analyzed with digital microscopy. Cell density, cell distribution, cell shape, cell aspect ratio, and cell wall thickness of an extruded sheet may be held constant when extrusion parameters such as recipe, temperature, and cooling rate are the same. In the present disclosure, formation of wrinkled material was found to occur when the exit angle of curvature increased from 44° to 90° (see, Example 1, FIGS. 5-7). Without wishing to be bound by theory, one plausible explanation may be that cell density and dimensional morphology are a function of enclosed die volume exit angle, i.e., cell density and dimensional morphology may be altered upon exit from different enclosed die volume exit angles, thereby creating wrinkled material.

The disclosure herein provides methods of producing an insulative cellular material. In an embodiment, the insulative cellular material is polypropylene based. In an embodiment, the insulative cellular material is wrinkle- and/or crease-resistant. In an embodiment, a method of producing an insulative cellular material includes extruding a formulation as disclosed herein through an extruder die lips at an exit angle from about 0° to about 60°. In an embodiment, the formulation is extruded through die lips at an angle of about 0° to about 10°, about 10° to about 20°, about 20° to about 30°, about 30° to about 40°, about 40° to about 50°, about 50° to about 60°, about 40° to about 45°, 0° to about 20°, 0° to about 30°, 0° to about 40°, 0° to about 50°, about 10° to about 60°, about 10° to about 50°, about 10° to about 40°, about 10° to about 30°, about 20° to about 60°, about 20° to about 50°, about 20° to about 40°, about 30° to about 60°, about 30° to about 50°, or about 40° to about 60°. An embodiment includes the method wherein the die exit angle may be about 10°, 20°, 30°, 40°, 41°, 42°, 43°, 44°, 45°, 46°, 47°, 48°, 49°, 50°, or 60°.

In an embodiment of a method of producing an insulative cellular material, wherein the formulation comprises i) a first polymer material comprising at least one high melt strength polypropylene homopolymer, and ii) a second polymer material comprising at least one polymer selected from the group consisting of crystalline polypropylene homopolymer, impact polypropylene copolymer, and mixtures thereof. In an embodiment, the formulation further comprises at least one nucleating agent. In an embodiment, the formulation further comprises at least one slip agent. In an embodiment of a method of producing an insulative cellular material, cell dimensional attributes are according to y=Ax^{K}, wherein either x or y is cell density of the insulative cellular polypropylene-based material and the non-cell density variable is cell length, cell width, or cell wall thickness of the insulative cellular polypropylene-based material.

It was unexpectedly found that cell morphology, especially cell density, of an extruded sheet of insulative cellular polypropylene-based material in accordance with the present disclosure has an effect on the quality of the formed article, such as a cup, formed therewith. The effects of cell density and dimensional attributes on wrinkle resistance in insulative cellular polypropylene-based material may be illustrated through examining cell morphology data from different formulations and process conditions, thus creating a wrinkle-resistance prediction model based on power law regression.

In exemplary embodiments, the cell density of insulative cellular polypropylene-based material in accordance with the present disclosure may affect the material's resistance to wrinkling. In other exemplary embodiments, the total number of cells of insulative cellular polypropylene-based material may affect the material's wrinkle resistance to wrinkling. In other exemplary embodiments, the cell aspect ratio in a circumferential direction 10 of an insulative cup 12, may affect the material's resistance to wrinkling. In other exemplary embodiments, the cell aspect ratio in an axial direction 20 of the insulative cup 12, may affect the material's resistance to wrinkling.

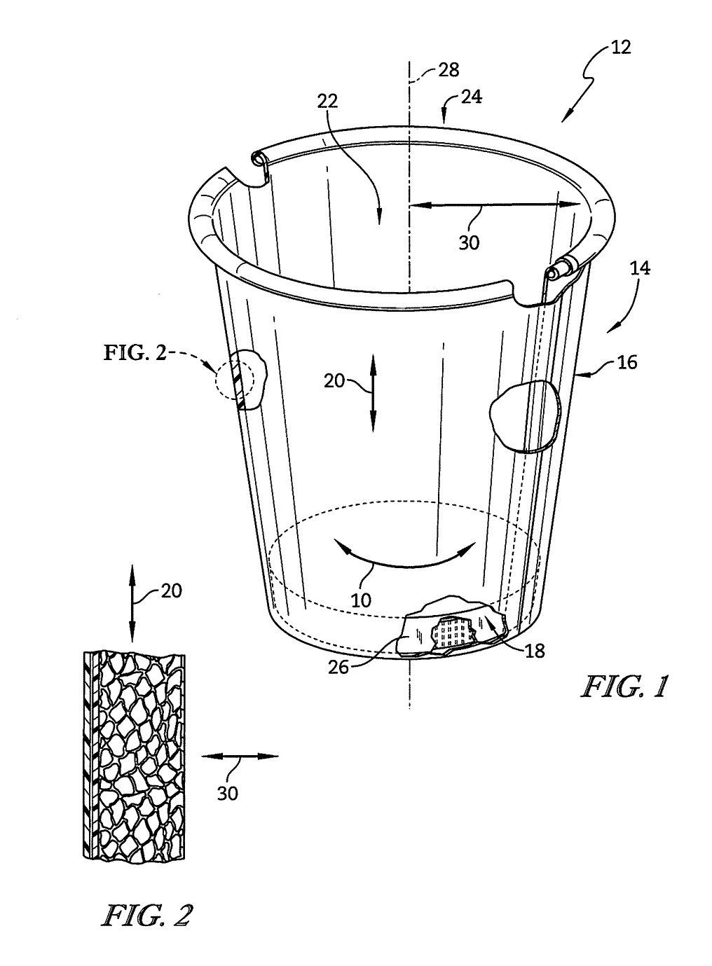

As shown in FIG. 1, insulative cup 12 includes includes a body 14 having a sleeve-shaped side wall 16 and a floor 18 as shown in FIG. 1. Floor 18 is coupled to body 14 and cooperates with side wall 16 to form an interior region 22 therebetween for storing food, liquid, or any suitable product. Body 14 also includes a rolled brim 24 coupled to an upper end of side wall 16 and a floor mount 26 coupled to a lower end of side wall 16 and to floor 18 as shown in FIG. 1. Side wall 16 is arranged to extend around an axis 28 in circumferential direction 10. Side wall 16 is arranged to extend along axis 28 in axial direction 20 as shown in FIGS. 1 and 2. Side wall 16 is spaced apart from axis 28 in a radial direction 30 as shown in FIGS. 1 and 2. U.S. application Ser. No. 13/491,007, filed Jun. 7, 2012 is hereby incorporated by reference in its entirety for disclosure relating to an insulative cup.

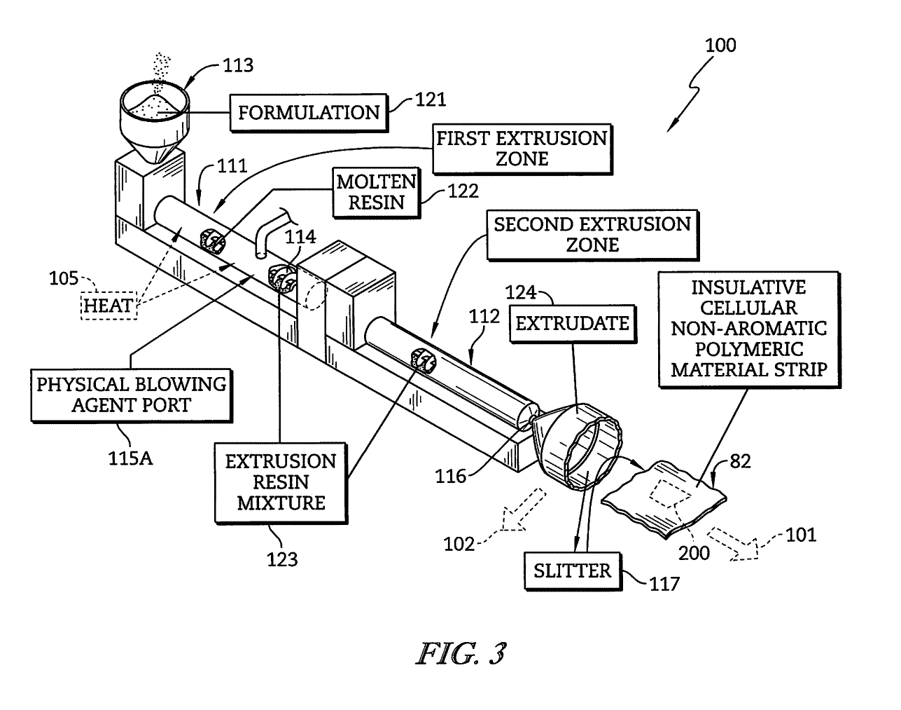

Insulative cup 12 includes a sheet of insulative cellular non-aromatic polymeric material made according to a material-forming process 100 as shown in FIG. 3. Material-forming process 100 begins with a polypropylene-based formulation 121 in accordance with the present disclosure which is used to produce strip 82 of insulative cellular non-aromatic polymeric material as shown in FIG. 3. Formulation 121 is heated and extruded in two stages to produce a tubular extrudate 124 that can be slit to provide strip 82 of insulative cellular non-aromatic polymeric material as illustrated, for example, in FIG. 3. A blowing agent in the form of a liquefied inert gas is introduced into a molten resin 122 in the first extrusion zone. As an example, material-forming process 100 uses a tandem-extrusion technique in which a first extruder 111 and a second extruder 112 cooperate to extrude strip 82 of insulative cellular non-aromatic polymeric material.

As shown in FIG. 3, a formulation 121 of insulative cellular non-aromatic polymeric material is loaded into a hopper 113 that is coupled to first extruder 111. Formulation 121 of insulative cellular non-aromatic polymeric material is moved from hopper 113 by a screw 114 included in first extruder 111. Formulation 121 is transformed into a molten resin 122 in a first extrusion zone of first extruder 111 by application of heat 105 and pressure from screw 114 as suggested in FIG. 3.

In exemplary embodiments, a physical blowing agent may be introduced and mixed into molten resin 122 after molten resin 122 is established. In exemplary embodiments, as discussed further herein, the physical blowing agent may be a gas introduced as a pressurized liquid via a port 115A and mixed with molten resin 122 to form a molten extrusion resin mixture 123 as shown in FIG. 3.

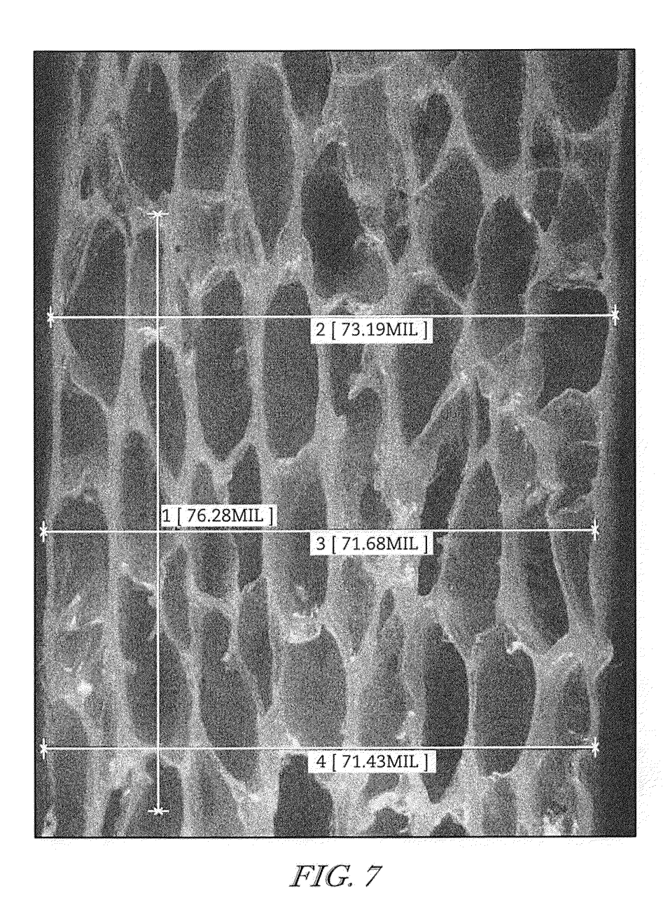

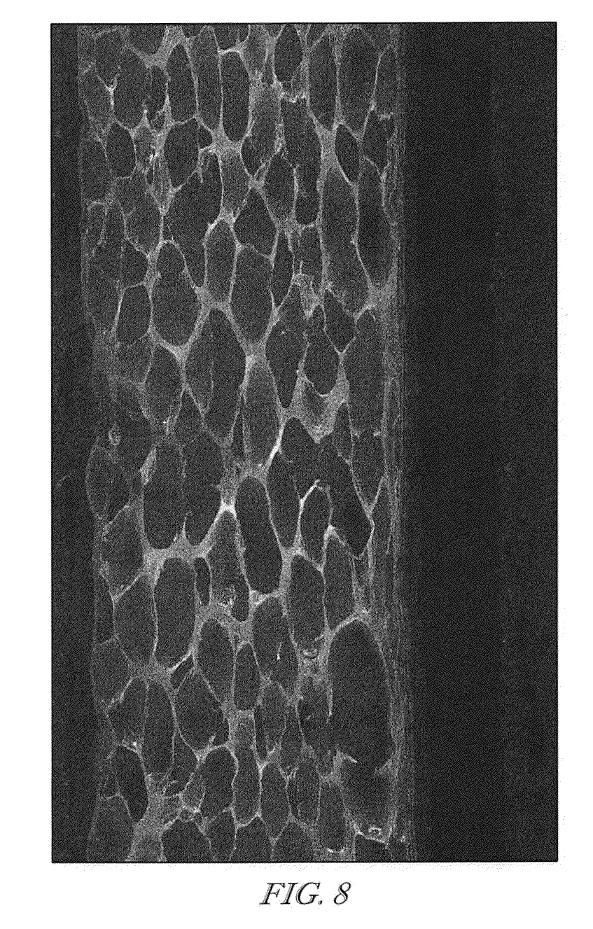

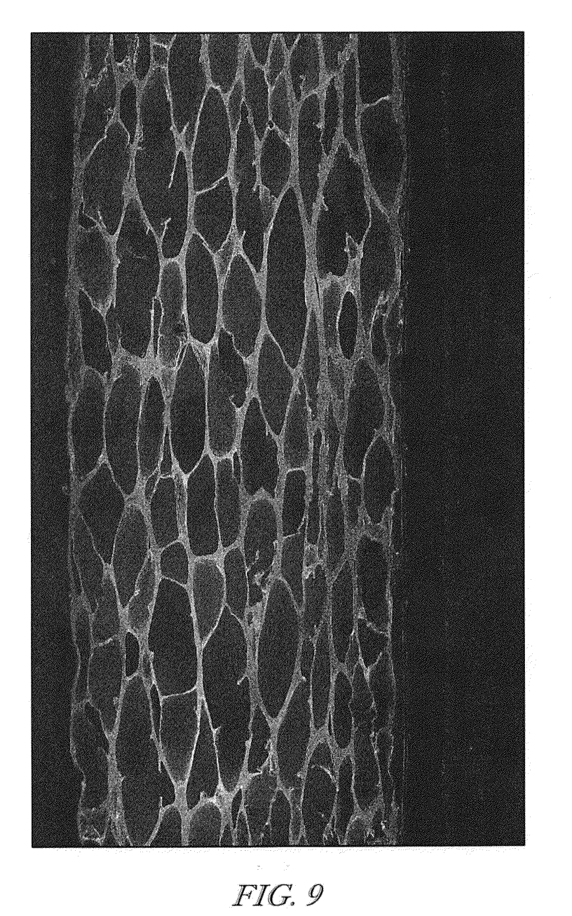

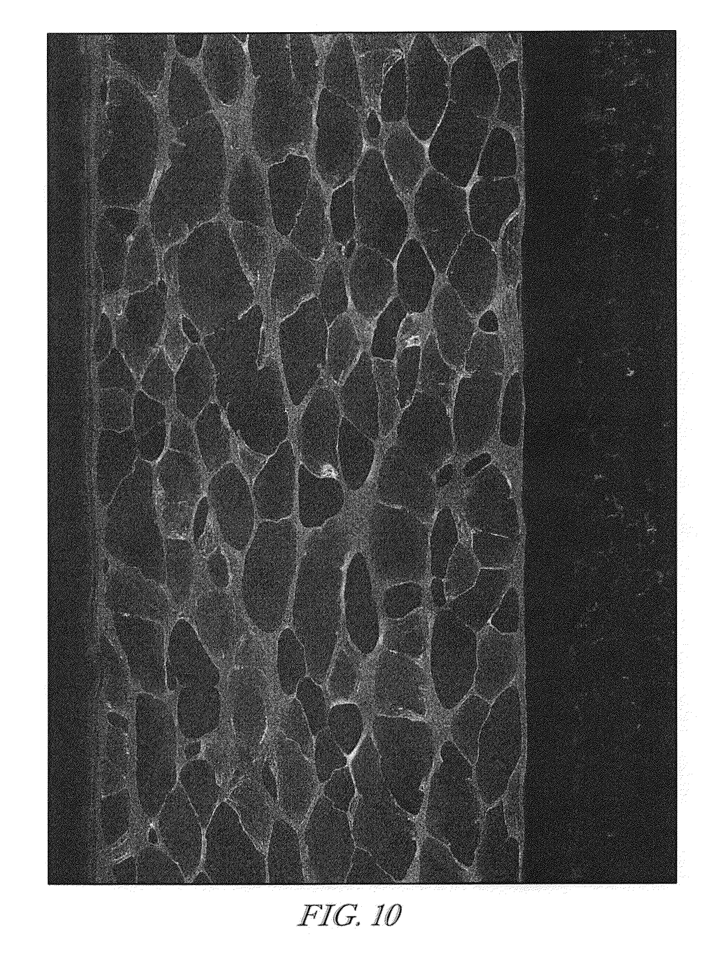

Extrusin resin mixture 123 is conveyed by screw 114 into a second extrusion zone included in second extruder 112 as shown in FIG. 7. There, extrusion resin mixture 123 is further processed by second extruder 112 before being expelled through an extrusion die 116 coupled to an end of second extruder 112 to form an extrudate 124. As extrusion resin mixture 123 passes through extrusion die 116, gas comes out of solution in extrusion resin mixture 123 and begins to form cells and expand so that extrudate 124 is established. The extrudate 124 may be formed by an annular extrusion die 116 to form a tubular extrudate 124. A slitter 117 then cuts extrudate 124 to establish strip 82 of insulative cellular non-aromatic polymeric material as shown in FIG. 3. U.S. application Ser. No. 14/462,073, filed Aug. 18, 2014 is hereby incorporated by reference in its entirety for disclosure relating to formulations of insulative cellular non-aromatic polymeric material.

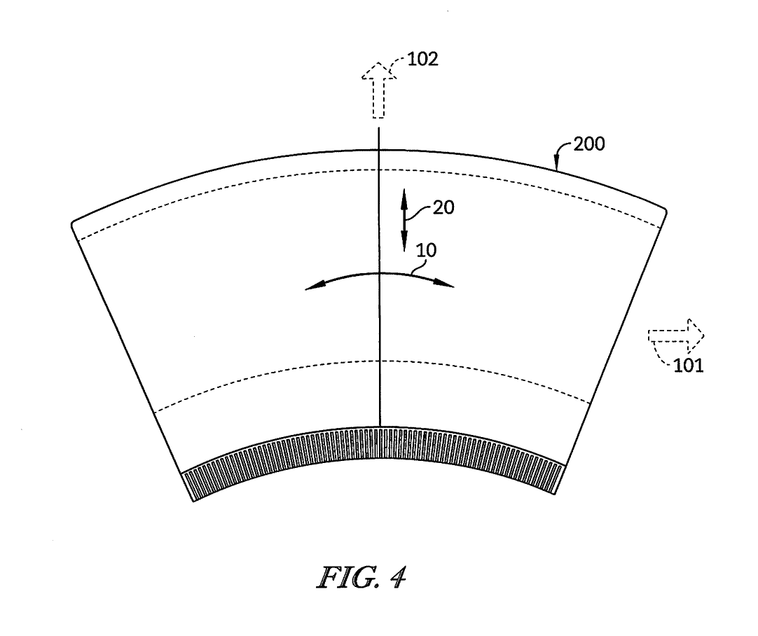

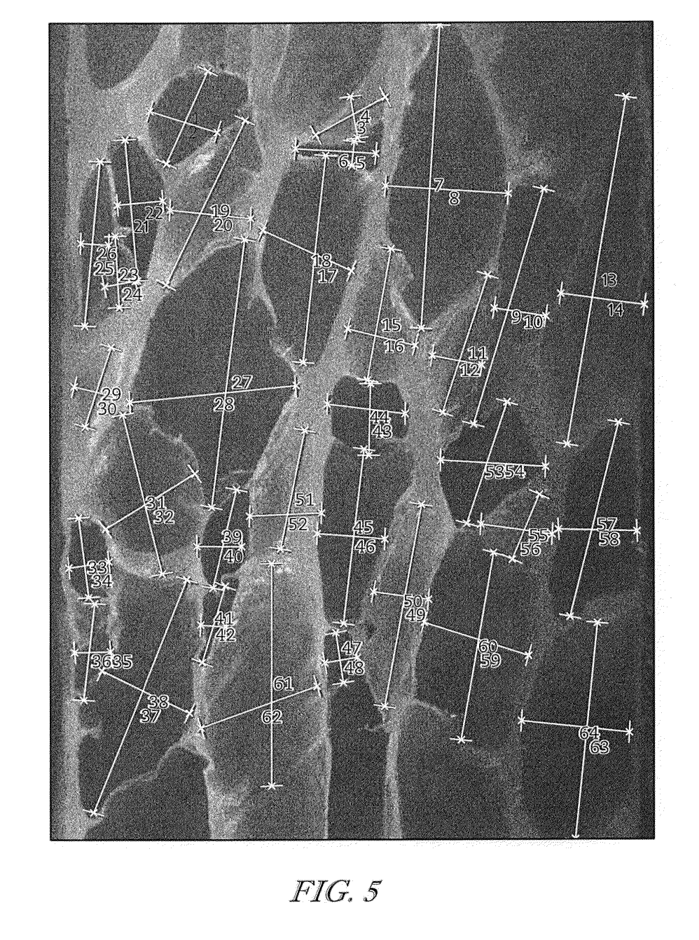

A blank 200 used to form a portion of insulative cup 10 is shown in phantom in FIG. 3 and in FIG. 4. In one example, blank is oriented on strip 82 such that circumferetial direction 10 is aligned with a machine direction 101 as shown in FIGS. 3 and 4. As a result axial direction 20 is aligned with a cross direction 102 as shown in FIGS. 3 and 4. U.S. application Ser. No. 13/526,444, filed Jun. 18, 2012 is hereby incorporated by reference in its entirety for disclosure relating to processes for forming an insulative cup 10 using a blank. Blank 200 may be oriented in any direction. Blank 200 orientation may influence cell morphology.

In other exemplary embodiments, the cell length of insulative cellular polypropylene-based material may affect the material's resistance to wrinkling. When cells are measured in the circumferential direction 10, cell length is the circumferential distance in the circumferential direction 10. When cells are measured in the axial direction 20, cell length is the axial distance in the axial direction 20.

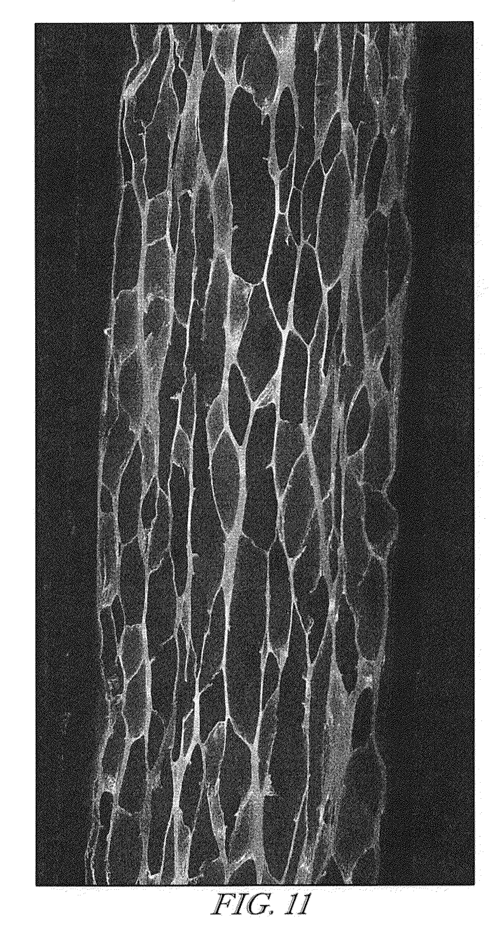

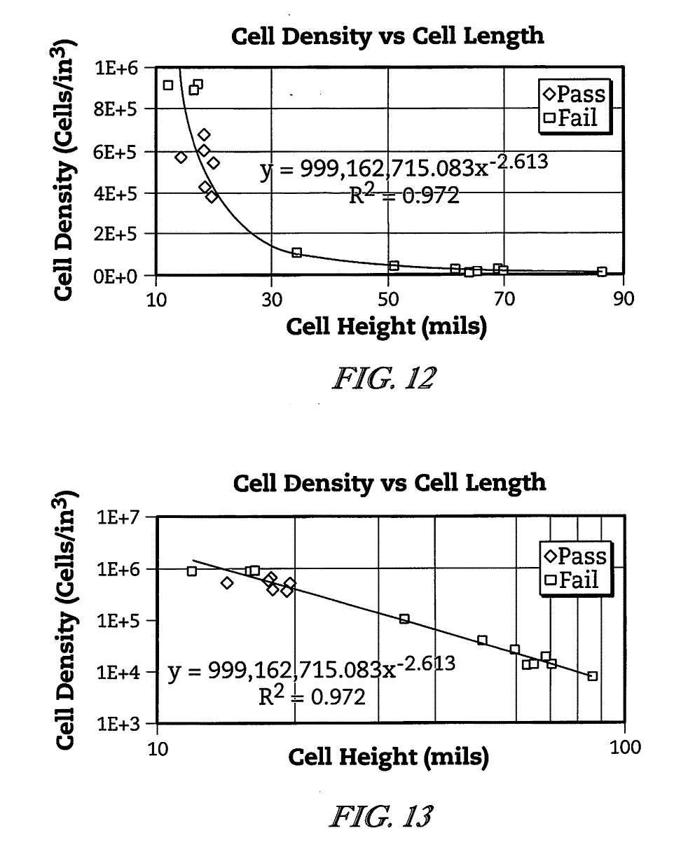

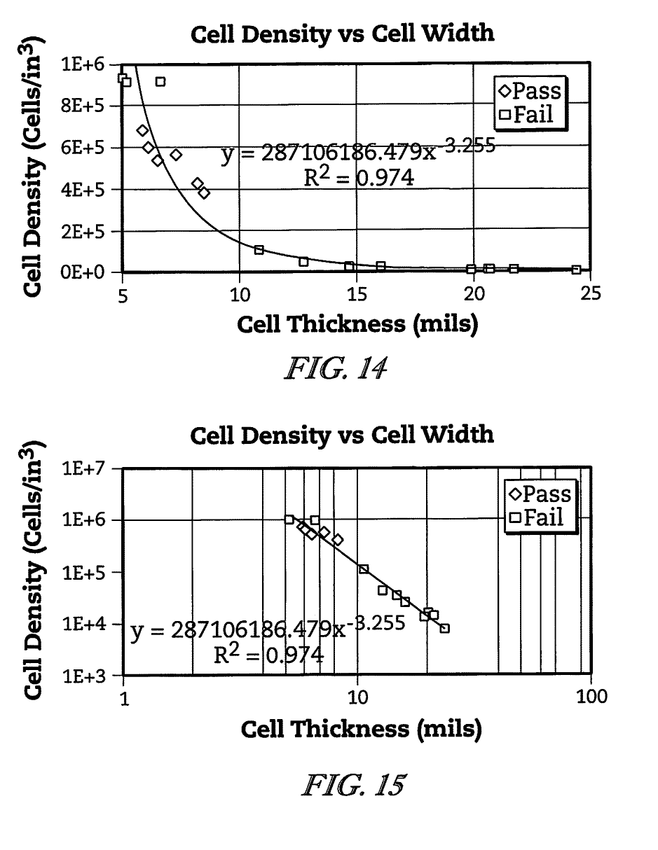

In other exemplary embodiments, the cell width of insulative cellular polypropylene-based material may affect the material's resistance to wrinkling. Cell width is the maximum radial distance measured in a radial direction. In other exemplary embodiments, the cell wall thickness of insulative cellular polypropylene-based material may affect the material's resistance to wrinkling. In other exemplary embodiments, cell dimensional attributes may follow a power law that is independent of formula and processing conditions (see, Example 2, FIGS. 12-19). The present disclosure also provides process know how and a basis for predicting wrinkle resistance in insulative cellular polypropylene-based material that is independent of material formula and processing conditions.

The insulative cellular polypropylene-based material of the present disclosure satisfies a long-felt need for a material that may be formed into an article, such as an insulative cup, that includes the features of wrinkle-resistance and crease-resistance as described herein, as well as many, if not all, of the features of insulative performance, recyclability, puncture resistance, frangibility resistance, and microwavability, which features are described in U.S. patent application Ser. Nos. 13/491,007 and 13/491,327 both of which are incorporated herein by reference in their entirety.

Nucleating agent means a chemical or physical material that provides sites for cells to form in a molten formulation mixture. Nucleating agents may include chemical nucleating agents and physical nucleating agents. The nucleating agent may be blended with the formulation that is introduced into the hopper of the extruder. Alternatively, the nucleating agent may be added to the molten resin mixture in the extruder.

Suitable physical nucleating agents have desirable particle size, aspect ratio, and top-cut properties. Examples include, but are not limited to, talc, CaCO3, mica, and mixtures of at least two of the foregoing. One representative example is Heritage Plastics HT6000 Linear Low Density Polyethylene (LLDPE) Based Talc Concentrate.

Suitable chemical nucleating agents decompose to create cells in the molten formulation when a chemical reaction temperature is reached. These small cells act as nucleation sites for larger cell growth from a physical or other type of blowing agent. In one example, the chemical nucleating agent is citric acid or a citric acid-based material. One representative example is HYDROCEROL™ CF-40E (available from Clariant Corporation), which contains citric acid and a crystal nucleating agent.

A blowing agent refers to a physical or a chemical blowing agent (or combination of materials) that acts to expand nucleation sites. Blowing agents may include only chemical blowing agents, only physical blowing agents, combinations thereof, or several types of chemical and physical blowing agents. The blowing agent acts to reduce density by forming cells in the molten formulation at the nucleation sites. The blowing agent may be added to the molten resin mixture in the extruder.

Chemical blowing agents are materials that degrade or react to produce a gas. Chemical blowing agents may be endothermic or exothermic. Chemical blowing agents typically degrade at a certain temperature to decompose and release gas. One example of a chemical blowing agent is citric acid or citric-based material. One representative example is HYDROCEROL™ CF-40E (available from Clariant Corporation), which contains citric acid and a crystal nucleating agent. Here, the citric acid decomposes at the appropriate temperature in the molten formulation and forms a gas which migrates toward the nucleation sites and grows cells in the molten formulation. If sufficient chemical blowing agent is present, the chemical blowing agent may act as both the nucleating agent and the blowing agent.

In another example, chemical blowing agents may be selected from the group consisting of azodicarbonamide; azodiisobutyro-nitrile; benzenesulfonhydrazide; 4,4-oxybenzene sulfonylsemicarbazide; p-toluene sulfonyl semi-carbazide; barium azodicarboxylate; N,N′-dimethyl-N,N′-dinitrosoterephthalamide; trihydrazino triazine; methane; ethane; propane; n-butane; isobutane; n-pentane; isopentane; neopentane; methyl fluoride; perfluoromethane; ethyl fluoride; 1,1-difluoroethane; 1,1,1-trifluoroethane; 1,1,1,2-tetrafluoro-ethane; pentafluoroethane; perfluoroethane; 2,2-difluoropropane; 1,1,1-trifluoropropane; perfluoropropane; perfluorobutane; perfluorocyclobutane; methyl chloride; methylene chloride; ethyl chloride; 1,1,1-trichloroethane; 1,1-dichloro-1-fluoroethane; 1-chloro-1,1-difluoroethane; 1,1-dichloro-2,2,2-trifluoroethane; 1-chloro-1,2,2,2-tetrafluoroethane; trichloromonofluoromethane; dichlorodifluoromethane; trichlorotrifluoroethane; dichlorotetrafluoroethane; chloroheptafluoropropane; dichlorohexafluoropropane; methanol; ethanol; n-propanol; isopropanol; sodium bicarbonate; sodium carbonate; ammonium bicarbonate; ammonium carbonate; ammonium nitrite; N,N′-dimethyl-N,N′-dinitrosoterephthalamide; N,N′-dinitrosopentamethylene tetramine; azodicarbonamide; azobisisobutylonitrile; azocyclohexylnitrile; azodiaminobenzene; bariumazodicarboxylate; benzene sulfonyl hydrazide; toluene sulfonyl hydrazide; p,p′-oxybis(benzene sulfonyl hydrazide); diphenyl sulfone-3,3′-disulfonyl hydrazide; calcium azide; 4,4′-diphenyl disulfonyl azide; p-toluene sulfonyl azide; and combinations thereof.

In an illustrative embodiment, a nucleating agent may be about 0.1% to about 20% (w/w), about 0.25% to about 20%, about 0.5% to about 20%, about 0.75% to about 20%, about 1% to about 20%, about 1.5% to about 20%, about 2% to about 20%, about 2.5% to about 20%, about 3% to about 20%, about 3% to about 20%, about 4% to about 20%, about 4.5% to about 20%, about 5% to about 20%, about 0.1% to about 10%, about 0.25% to about 10%, about 0.5% to about 10%, about 0.75% to about 10%, about 1.0% to about 10%, about 1.5% to about 10%, about 1.0% to about 10%, about 2.0% to about 10%, about 2.5% to about 10%, about 3.0% to about 10%, about 3.5% to about 10%, about 4.0% to about 10%, about 4.5% to about 10%, about 5.0% to about 10%, about 0.1% to about 5%, about 0.25% to about 5%, about 0.5% to about 5%, about 0.75% to about 5%, about 1% to about 5%, about 1.5% to about 5%, about 1% to about 5%, about 2% to about 5%, about 2.5% to about 5%, about 3% to about 5%, about 3.5% to about 5%, or about 4% to about 5%, or about 4.5% to about 5%. In an embodiment, a nucleating agent may be about 0.5%, about 1%, about 1.5%, about 2%, about 2.5%, about 3%, about 4%, or about 5% (w/w). In an embodiment, the polymeric material lacks a nucleating agent. In an embodiment, the polymeric material lacks talc.

In an illustrative embodiment, a chemical blowing agent may be about 0 to about 5% (w/w), about 0.1% to about 5% (w/w), about 0.25% to about 5%, about 0.5% to about 5%, about 0.75% to about 5%, about 1% to about 5%, about 1.5% to about 5%, about 2% to about 5%, about 3% to about 5%, about 4% to about 5%, 0 to about 4% (w/w), about 0.1% to about 4% (w/w), about 0.25% to about 4%, about 0.5% to about 4%, about 0.75% to about 4%, about 1% to about 4%, about 1.5% to about 4%, about 2% to about 4%, about 3% to about 4%, 0 to about 3% (w/w), about 0.1% to about 3% (w/w), about 0.25% to about 3%, about 0.5% to about 3%, about 0.75% to about 3%, about 1% to about 3%, about 1.5% to about 3%, about 2% to about 3%, 0 to about 2%, about 0.1% to about 2% (w/w), about 0.25% to about 2%, about 0.5% to about 2%, about 0.75% to about 2%, about 1% to about 2%, about 1.5% to about 2%, 0 to about 1%, about 0.1% to about 1%, about 0.5% to about 1%, or about 0.75% to about 1%. In an illustrative embodiment, a chemical blowing agent may be about 0.1%, 0.5%, 0.75%, 1%, 1.5% or about 2%. In one aspect of the present disclosure, where a chemical blowing agent is used, the chemical blowing agent may be introduced into the material formulation that is added to the hopper.

One example of a physical blowing agent is nitrogen (N₂). The N₂ is pumped into the molten formulation via a port in the extruder as a supercritical fluid. The molten material with the N₂ in suspension then exits the extruder via a die where a pressure drop occurs. As the pressure drop happens, N₂ moves out of suspension toward the nucleation sites where cells grow. Excess gas blows off after extrusion with the remaining gas trapped in the cells formed in the extrudate. Other suitable examples of physical blowing agents include, but are not limited to, carbon dioxide (CO₂), helium, argon, air, pentane, butane, other alkanes, mixtures of the foregoing, and the like.

In one aspect of the present disclosure, at least one slip agent may be incorporated into the formulation to aid in increasing production rates. Slip agent (also known as a process aid) is a term used to describe a general class of materials which are added to the formulation and provide surface lubrication to the polymer during and after conversion. Slip agents may also reduce or eliminate die drool. Representative examples of slip agent materials include amides of fats or fatty acids, such as, but not limited to, erucamide and oleamide. In one exemplary aspect, amides from oleyl (single unsaturated C-18) through erucyl (C-22 single unsaturated) may be used. Other representative examples of slip agent materials include low molecular weight amides and fluoroelastomers. Combinations of two or more slip agents may be used. Slip agents may be provided in a master batch pellet form and blended with the resin formulation. One example of a suitable slip agent is Ampacet 102823 Process Aid PE MB LLDPE.

In an embodiment, a slip agent may be about 0% to about 10% (w/w), about 0.5% to about 10% (w/w), about 1% to about 10% (w/w), about 2% to about 10% (w/w), about 3% to about 10% (w/w), about 4% to about 10% (w/w), about 5% to about 10% (w/w), about 6% to about 10% (w/w), about 7% to about 10% (w/w), about 8% to about 10% (w/w), about 9% to about 10% (w/w), about 0% to about 9% (w/w), about 0.5% to about 9% (w/w), about 1% to about 9% (w/w), about 2% to about 9% (w/w), about 3% to about 9% (w/w), about 4% to about 9% (w/w), about 5% to about 9% (w/w), about 6% to about 9% (w/w), about 7% to about 9% (w/w), about 8% to about 9% (w/w), about 0% to about 8% (w/w), about 0.5% to about 8% (w/w), about 1% to about 8% (w/w), about 2% to about 8% (w/w), about 3% to about 8% (w/w), about 4% to about 8% (w/w), about 5% to about 8% (w/w), about 6% to about 8% (w/w), about 7% to about 8% (w/w), about 0% to about 7% (w/w), about 0.5% to about 7% (w/w), about 1% to about 7% (w/w), about 2% to about 7% (w/w), about 3% to about 7% (w/w), about 4% to about 7% (w/w), about 5% to about 7% (w/w), about 6% to about 7% (w/w), about 0% to about 6% (w/w), about 0.5% to about 6% (w/w), about 1% to about 6% (w/w), about 2% to about 6% (w/w), about 3% to about 6% (w/w), about 4% to about 6% (w/w), about 5% to about 6% (w/w), about 0% to about 5% (w/w), about 0.5% to about 5% (w/w), about 1% to about 5% (w/w), about 2% to about 5% (w/w), about 3% to about 5% (w/w), about 4% to about 5% (w/w), about 0% to about 4% (w/w), about 0.5% to about 4% (w/w), about 1% to about 4% (w/w), about 2% to about 4% (w/w), about 3% to about 4% (w/w), about 0% to about 3% (w/w), about 0.5% to about 3% (w/w), about 1% to about 3% (w/w), about 2% to about 3% (w/w), about 0% to about 2% (w/w), about 0.5% to about 2% (w/w), about 1% to about 2% (w/w), about 0% to about 1% (w/w), or about 0.5% to about 1% (w/w). In an embodiment, a slip agent may be about 0.5%, about 1%, about 2%, about 3%, about 4%, about 5%, about 6%, about 7%, about 8%, about 9%, or about 10% (w/w). In an embodiment, the formulation lacks a slip agent.

In an embodiment, a colorant may be about 0% to about 20% (w/w), about 0% to about 15% (w/w), about 0% to about 10% (w/w), about 0% to about 5% (w/w), about 0% to about 4% (w/w), about 0.1% to about 4%, about 0.25% to about 4%, about 0.5% to about 4%, about 0.75% to about 4%, about 1.0% to about 4%, about 1.5% to about 4%, about 2.0% to about 4%, about 2.5% to about 4%, about 3% to about 4%, about 0% to about 3.0%, about 0% to about 2.5%, about 0% to about 2.25%, about 0% to about 2.0%, about 0% to about 1.5%, about 0% to about 1.0%, about 0% to about 0.5%, about 0.1% to about 3.5%, about 0.1% to about 3.0%, about 0.1% to about 2.5%, about 0.1% to about 2.0%, about 0.1% to about 1.5%, about 0.1% to about 1.0%, about 1% to about 5%, about 1% to about 10%, about 1% to about 15%, about 1% to about 20%, or about 0.1% to about 0.5%. In an embodiment, a formulation lacks a colorant.

In one exemplary embodiment, a formulation used to produce the cellular polymeric material includes at least one polymeric material. The polymeric material may include one or more base resins. In one example, the base resin is polypropylene. In an illustrative embodiment, a base resin may include Borealis WB140 HMS polypropylene homopolymer. In another illustrative embodiment, a base resin may include Braskem F020HC polypropylene homopolymer. In an embodiment, a base resin may include both Borealis WB140 HMS polypropylene homopolymer and Braskem F020HC polypropylene homopolymer.

In embodiments with more than one polypropylene copolymer base resin, different polypropylene copolymers may be used depending on the attributes desired in the formulation. Depending on the desired characteristics, the ratio of two polypropylene resins may be varied, e.g., 10%/90%, 20%/80%, 25%/75%, 30%/70%, 35%/65%, 40%/60%, 45%/55%, 50%/50%, etc. In an embodiment, a formulation includes three polypropylene resins in the base resin. Again, depending on the desired characteristics, the percentage of three polypropylene resins may be varied, 33%/33%/33%, 30%/30%/40%, 25%/25%/50%, etc.

In illustrative embodiments, a polymeric material includes a primary base resin. In illustrative embodiments, a base resin may include polypropylene. In illustrative embodiments, an insulative cellular non-aromatic polymeric material comprises a polypropylene base resin having a high melt strength and a polypropylene copolymer or homopolymer (or both). In one example, the polypropylene base resin has a drawdown force greater than about 15 cN. In another example, the polypropylene base resin has a drawdown force greater than about 20 cN. In another example, the polypropylene base resin has a drawdown force greater than about 25 cN. In another example, the polypropylene base resin has a drawdown force greater than about 35 cN.

In an embodiment, a formulation of the polymeric material comprises about 50 wt % to about 100 wt %, about 70 wt % to about 100 wt %, about 50 wt % to about 99 wt %, 50 wt % to about 95 wt %, about 50 wt % to about 85 wt %, about 55 wt % to about 85 wt %, about 80 wt % to about 85 wt %, about 80 wt % to about 90 wt %, about 80 wt % to about 91 wt %, about 80 wt % to about 92 wt %, about 80 wt % to about 93 wt %, about 80 wt % to about 94 wt %, about 80 wt % to about 95 wt %, about 80 wt % to about 96 wt %, about 80 wt % to about 97 wt %, about 80 wt % to about 98 wt %, about 80 wt % to about 99 wt %, about 85 wt % to about 90 wt %, or about 85 wt % to about 95 wt % of the primary base resin. In an embodiment, a colorant may be about 80%, 81%, 82%, 83%, 84%, 85%, 86%, 87%, 88%, 89%, 90%, 91%, 92%, 93%, 94%, 95%, 96%, 97%, 98%, 99%, or 100%.

As defined hereinbefore, any suitable primary base resin may be used. One illustrative example of a suitable polypropylene base resin is DAPLOY™ WB140 homopolymer (available from Borealis A/S) which is a high melt strength structural isomeric modified polypropylene homopolymer.

In illustrative embodiments, a polymeric material includes a secondary resin, wherein the secondary resin may be a polypropylene copolymer or homopolymer (or both). In another embodiment, a secondary resin may be about 0 wt % to about 50 wt %, about 0 wt % to about 30 wt %, about 0 wt % to about 25 wt %, about 0 wt % to about 20 wt %, about 0 wt % to about 15 wt %, about 10 wt % to about 50 wt %, about 10 wt % to about 40 wt %, about 10 wt % to about 30 wt %, about 10 wt % to about 25 wt %, about 10 wt % to about 20 wt %, or about 10 wt % to about 15 wt % of a secondary resin. In an embodiment, a polymeric material includes about 0 wt %, about 10 wt %, about 15 wt %, about 20 wt %, about 25 wt %, or about 30 wt %. In an embodiment, a polymeric material does not have a secondary resin. In an embodiment, a secondary resin may be a high crystalline polypropylene homopolymer, such as F020HC (available from Braskem) or PP 527K (available from Sabic). In an embodiment, a polymeric material lacks a secondary resin.

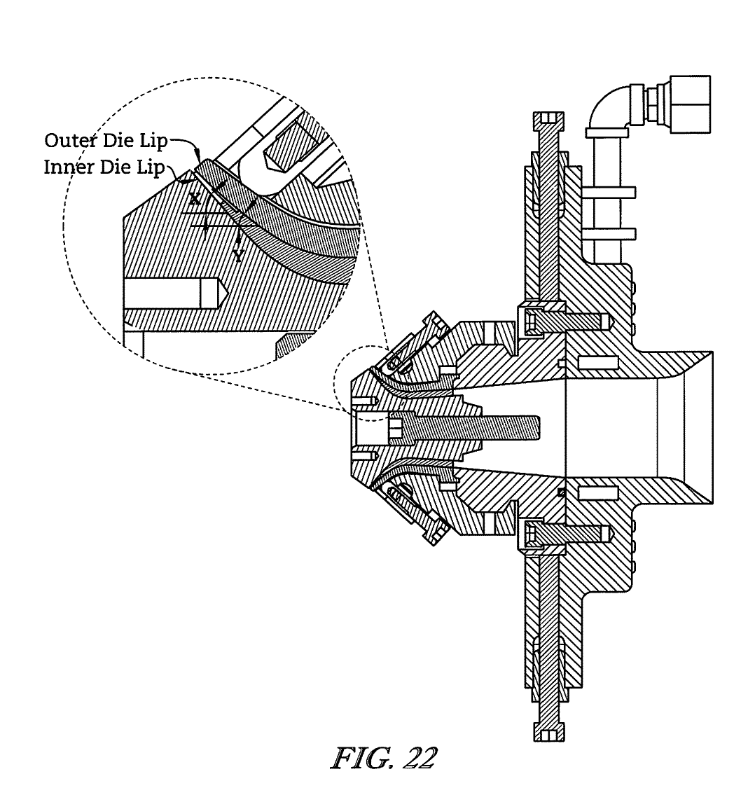

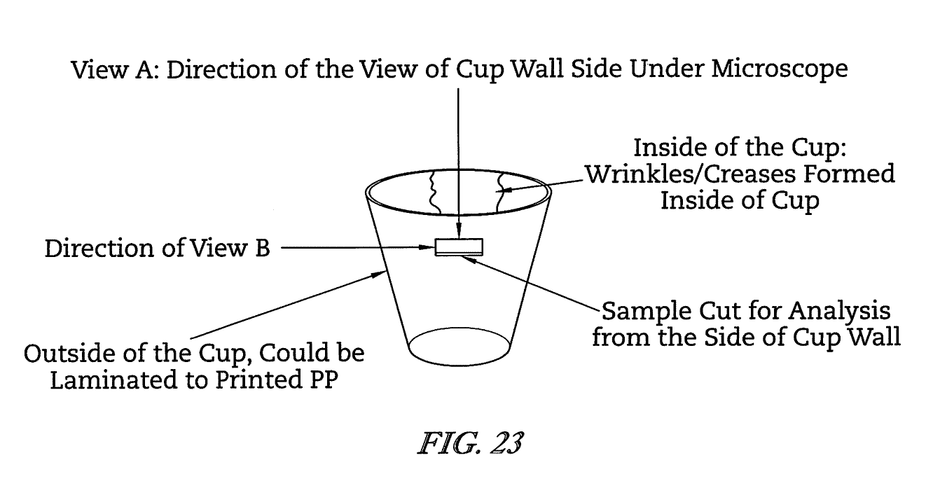

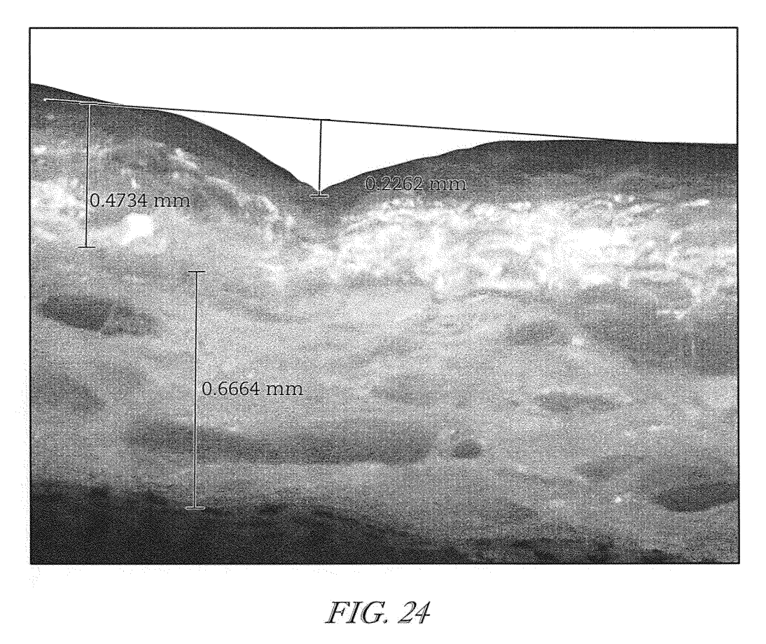

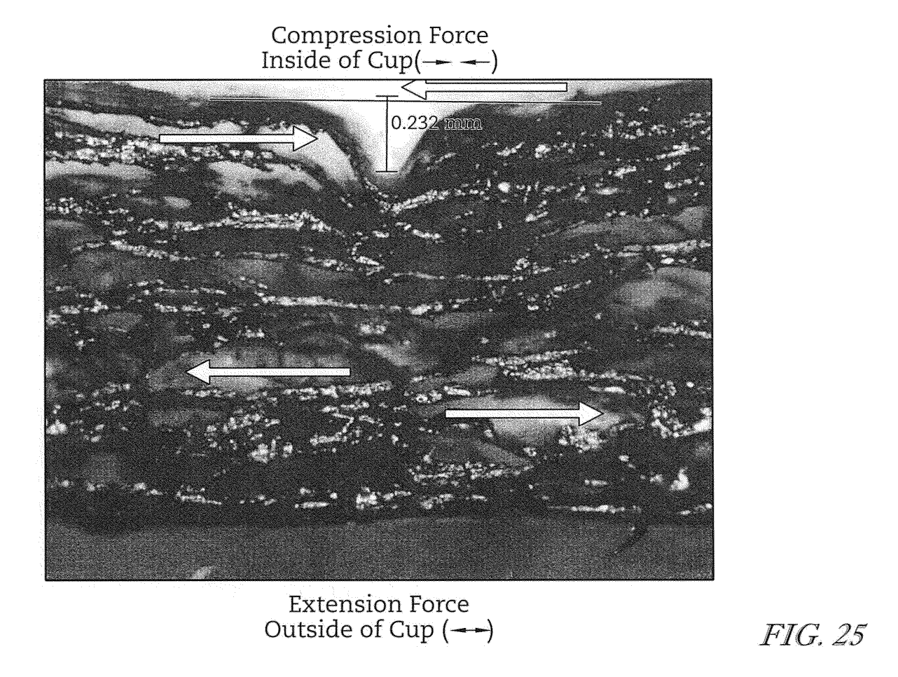

The term die exit angle means the angle subtended by the central axis of the torpedo mandrel and the outer surface of the torpedo mandrel adjacent the exit lip of an extrusion apparatus. Such an angle may be referred to as an inner lip angle, and is commonly understood to be angle X as shown in FIG. 22. The die exit angle may be an angle as disclosed in any of the following numbered lines 1-15:

1.) 1-60°

2.) 10-60°

3.) 20-60°

4.) 30-60°

5.) 30-58°

6.) 32-58°

7.) 35-58°

8.) 35-56°

9.) 37-54°

10.) 40-54°

11.) 40-52°

12.) 40-50°

13.) 40-48°

14.) 42-48°

15.) 42-46°

In particular embodiments of the disclosure, the die exit angle may be formed by an inner lip angle identified as X in FIG. 22 and an outer lip angle identified as Y in FIG. 22. Outer lip angle Y is the angle subtended by the lip of the extrusion apparatus and the central axis of a torpedo mandrel. Inner lip angle X is the angle subtended by the central axis of the torpedo mandrel and the outer surface of the torpedo mandrel adjacent the lip of the extrusion apparatus as shown in FIG. 22. Angles X and Y may be configured as disclosed in any of the following numbered lines 16-22:

16.) X is 45-60° and Y is 35-55°

17.) X is 47-58° and Y is 37-50°

18.) X is 47-56° and Y is 37-48°

19.) X is 47-54° and Y is 39-46°

20.) X is 48-54° and Y is 40-45°

21.) X is 49° and Y is 41°

22.) X is 53° and Y is 41°

In an embodiment, the process comprises extruding a formulation at any of the angles disclosed in numbered lines 1-22 above, wherein the formulation comprises:

50-100 wt % of a primary base resin

0-50 wt % of a secondary resin

0-5 wt % of a chemical blowing agent

0.1-20 wt % of a nucleating agent

0-20 wt % of a colorant

0-10 wt % of a slip agent

In an embodiment, the process comprises extruding a formulation at any of the angles defined in numbered paragraphs 1-22 above, wherein the formulation comprises:

50-100 wt % of a primary base resin

0-50 wt % of a secondary resin

0-2 wt % of a chemical blowing agent

0-20 wt % of a physical nucleating agent

0-20 wt % of a colorant

0-10 wt % of a slip agent

In an embodiment, the process comprises extruding a formulation at any of the angles disclosed in the numbered lines 1-22 above, wherein the formulation comprises:

75-85 wt % of a primary base resin

10-20 wt % of a secondary resin

0-0.1 wt % of a chemical blowing agent

0.1-3 wt % of a nucleating agent

0-2 wt % of a colorant

0-4 wt % of a slip agent

In an embodiment, the process comprises extruding a formulation at any of the angles disclosed in the numbered lines 1-22 above, wherein the formulation comprises:

50-99.65 wt % of the primary base resin

0-50 wt % of the secondary resin

0-10 wt % of the slip agent

0-10 wt % of the colorant

0.35-1.5 wt % of nucleating agent

In an embodiment, the process comprises extruding a formulation at any of the angles disclosed in the numbered lines 1-22 above, wherein the formulation comprises:

50-95 wt % of the primary base resin

0-50 wt % of the secondary resin

0-10 wt % of the slip agent

0-10 wt % of the colorant

0.4-1.2 wt % of nucleating agent

In an embodiment, the process comprises extruding a formulation at any of the angles disclosed in the numbered lines 1-22 above, wherein the formulation comprises:

55-85 wt % of the primary base resin

0-50 wt % of the secondary resin

0-10 wt % of the slip agent

0-10 wt % of the colorant

0.45-1.25 wt % of nucleating agent

In an embodiment, the process comprises extruding a formulation at any of the angles disclosed in the numbered lines 1-22 above, wherein the formulation comprises:

50-99.69 wt % of the primary base resin

0-50 wt % of the secondary resin

0-10 wt % of the slip agent

0-10 wt % of the colorant

0.01-1.5 wt % of the primary nucleating agent

0.3-1.7 wt % of the secondary nucleating agent

In an embodiment, the process comprises extruding a formulation at any of the angles disclosed in the numbered lines 1-22 above, wherein the formulation comprises:

50-95 wt % of the primary base resin

0-50 wt % of the secondary resin

0-10 wt % of the slip agent

0-10 wt % of the colorant

0.02-1.0 wt % of the primary nucleating agent

0.4-1.5 wt % of the secondary nucleating agent

In an embodiment, the process comprises extruding a formulation at any of the angles disclosed in the numbered lines 1-22 above, wherein the formulation comprises:

55-85 wt % of the primary base resin

0-50 wt % of the secondary resin

0-10 wt % of the slip agent

0-10 wt % of the colorant

0.03-0.7 wt % of the primary nucleating agent

0.45-1.25 wt % of the secondary nucleating agent

In an embodiment, the process comprises extruding a formulation at any of the angles disclosed in the numbered lines 1-22 above, wherein the formulation comprises:

78-83 wt % of a primary base resin

14-16 wt % of a secondary resin

0-0.05 wt % of a chemical blowing agent

0.25-2 wt % of a nucleating agent

1-2 wt % of a colorant

1.5-3.5 wt % of a slip agent

In the preceding embodiments, the primary base resin may comprise polypropylene. In another illustrative embodiment, the primary base resin comprises at least one of Borealis WB140 HMS polypropylene homopolymer and Braskem F020HC polypropylene homopolymer. In another embodiment, the primary base resin is Borealis WB140 HMS polypropylene homopolymer.

In the preceding embodiments, the secondary resin may comprise at least one polypropylene copolymer or polypropylene homopolymer. In another embodiment, the secondary resin comprises at least one of Braskem F020HC polypropylene homopolymer and PP 527K (available from Sabic). In another embodiment, the secondary resin is Braskem F020HC polypropylene homopolymer.

In the preceding embodiments, the chemical blowing agent may comprise citric acid, or a citric acid-based material. In an illustrative embodiment the chemical blowing agent is Hydrocerol™ CF-40E (available from Clariant Corporation).

In the preceding embodiments, the nucleating agent may comprise talc, CaCO₃, mica, or mixtures thereof. In an illustrative embodiment, the nucleating agent is one or more of HT4HP talc (available from Heritage Plastics), HT6000 Linear Low Density Polyethylene (LLDPE) (available from Heritage Plastics), and Techmer PM PPM 16466 Silica. In another embodiment, the nucleating agent is HT4HP talc (available from Heritage Plastics) or Techmer PM PPM 16466 Silica. A primary nucleating agent may be defined as a chemical blowing agent or chemical foaming agent, itself comprising a nucleating agent. In another embodiment, a primary nucleating agent is Hydrocerol™ CF-40ETM (available from Clariant Corporation). In an illustrative embodiment, a secondary nucleating agent is selected from HPR-803i fibers (available from Milliken) or talc

In the preceding embodiments, the colorant may comprise at least one of Colortech 11933-19 TiO₂ PP or Cell Stabilizer. In another embodiment, the colorant is Colortech 11933-19 TiO₂ PP.

In the preceding embodiments, the slip agent may comprise one or more amides of fats or fatty acids, such as erucamide and oleamide. The slip agent may also comprise one or more low molecular weight amides and fluoroelastomers. In an embodiment, the slip agent is Ampacet 102823 Process Aid PE MB LLDPE.

The method of any of the preceding embodiments may also comprise adding CO₂ to the formulation prior to extrusion at a rate of 1-4 lbs/hr. In an embodiment, the CO₂ is added at a rate of 2-3 lbs/hr. In another embodiment, the CO₂ is added at a rate of 2.2-2.8 lbs/hr. Such practice may also be referred to as adding a physical blowing agent.

### EXAMPLES

The following examples are set forth for purposes of illustration only. Parts and percentages appearing in such examples are by weight unless otherwise stipulated.

### Example 1

### Formulation, Extrusion, and Sheet Formation

An exemplary formulation used to illustrate the present disclosure is presented below and is described in U.S. Provisional Application Ser. No. 61/719,096, the disclosure of which is hereby incorporated herein by reference in its entirety:

DAPLOY™ WB140 polypropylene homopolymer (available from Borealis A/S) was used as the polypropylene base resin. F020HC, available from Braskem, a polypropylene homopolymer resin, was used as the secondary resin. The two resins were blended with: Hydrocerol™ CF-40ETM as a chemical blowing agent, talc as a nucleation agent, CO₂ as a blowing agent, a slip agent, and titanium dioxide as a colorant. Percentages were:
81.45% Primary resin: high melt strength polypropylene Borealis WB140 HMS
15% Secondary resin: F020HC (Braskem) homopolymer polypropylene
0.05% Chemical blowing agent: Clariant Hyrocerol CF-40ETM
0.5% Nucleation agent: Heritage Plastics HT4HP Talc
1% Colorant: Colortech 11933-19 TiO₂ PP
2% Slip agent: Ampacet™ 102823 Process Aid LLDPE (linear low-density polyethylene), available from Ampacet Corporation

The formulation described above was added to an extruder hopper. The extruder heated the formulation to form a molten resin mixture. To this mixture was added 2.2 lbs/hr CO₂, which was injected into the resin blend to expand the resin and reduce density. The mixture thus formed was extruded through a die head into a sheet as described in U.S. application Ser. No. 13/491,007, the disclosure of which is hereby incorporated herein by reference in its entirety.

High resolution microscopy may be used to determine the dimensional properties of insulative cellular non-aromatic polymeric material. The Keyence VHX-1000 Digital Microscope was used to determine the dimensional properties of insulative cellular polypropylene-based material cells of the present disclosure. In one exemplary embodiment, cell length may be the dimensional property denoting maximum distance from top to bottom of cells running parallel to the circumferential direction 10 of an insulative cup made from insulative cellular non-aromatic polymeric material. In another exemplary embodiment, cell length may also be the dimensional property denoting maximum distance from top to bottom of cells running parallel to the axial direction 20 of an insulative cup made from insulative cellular non-aromatic polymeric material. In yet another exemplary embodiment, cell width may be the dimensional property denoting maximum distance from top to bottom of cells running in the radial direction of an insulative cup made from insulative cellular non-aromatic polymeric material. In still another exemplary embodiment, cell wall thickness may be the dimensional property denoting maximum distance between separated cell voids across a line running perpendicular to the circumferential and axial direction 20.

In order to assess the effect of cell morphology of an extruded sheet of insulative cellular polypropylene-based material on the quality of an article formed therewith, such as an insulative cup, a minimum of 700 measurement points were chosen for each of the length and width dimensional properties in order to verify consistency throughout a strip of the material. A minimum of 200 measurement points were chosen for cell wall thickness as a dimensional property in order to verify consistency throughout the strip of insulative cellular polypropylene-based material. In one exemplary embodiment, a sheet of insulative cellular polypropylene-based material may be extruded from an enclosed die volume at an angle of 44°. In another exemplary embodiment, a sheet of insulative cellular polypropylene-based material may be extruded from an enclosed die volume at an angle of 90°. A sheet of insulative cellular polypropylene-based material extruded at an angle of 44° is referred to herein as Material C. A sheet of insulative cellular polypropylene-based material extruded at an angle of 90° is referred to herein as Material D. Strips of insulative cellular polypropylene-based material from 44° and 90° exit angles were quantitatively compared as shown in FIGS. 5-7.

### Example 1

### Test Method

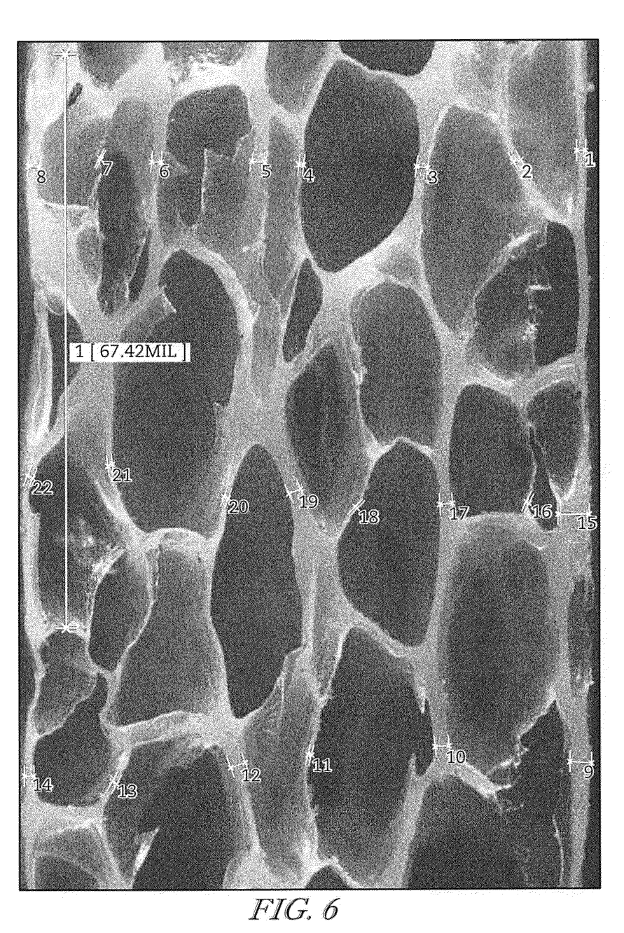

The typical testing method used for cell morphology measurement was as follows:
1.) Cut a side wall blank for an insulative cup as shown in FIG. 4 from a strip of insulative cellular polypropylene-based material as suggested by FIG. 3 or at any other orientation.
2.) Make an insulative cup using the side wall blank by the method disclosed in U.S. patent application Ser. No. 13/526,454 filed on Jun. 18, 2004, the disclosure of which is hereby incorporated by reference herein in its entirety.
3.) Cut a strip of the side wall of the insulative cup along the axial direction and circumferential direction.
4.) Hold the material with a flat clamp and use a razor blade to perform a fine shave.
5.) Focus the microscope at 100× and adjust lighting onto the material.
6.) Perform length and width measurements of each unique cell in the axial direction and circumferential direction orientation and record values as suggested by FIG. 5.
7.) Perform cell wall thickness measurements across 3-4 tangent lines to overall length of each unique cell in the axial and circumferential orientation and record the values as suggested by FIG. 6.
8.) Move microscope visual field so the bottom of the most upper incomplete cell is touching the bottom of the screen.
9.) Repeat steps 6-7 on each new unique cell until at least 0.500″ of the strip is measured.

A sheet of insulative cellular polypropylene-based material produced as described herein typically possessed a density of about 0.1615 g/cm³ and material thickness of about 0.066 inches (1.6764 mm).

### Example 1

### Test Results

The cell morphology of an extruded sheet of insulative cellular polypropylene-based material exiting the enclosed die volume at angles of 44° and 90° differed greatly in terms of cell height, cell width, cell aspect ratio, and cell wall thickness as shown in Table 1. In the circumferential direction, Material C had an average length of 19.54 mils (49.63 mm), an average width of 8.53 mils (21.67 mm), an average cell wall thickness of 1.02 mils (2.59 mm), and average aspect ratio of 2.29. In the circumferential direction, Material D had an average length of 17.01 mils (43.21 mm), an average width of 5.22 mils (13.26 mm), an average cell wall thickness of 0.77 mils (1.96 mm), and average aspect ratio of 3.26.

In the axial direction, Material C had an average length of 18.45 mils (46.86 mm), an average width of 8.28 mils (21.03 mm), an average cell wall thickness of 0.96 mils (2.44 mm), and average aspect ratio of 2.23. In the axial direction, Material D had an average length of 16.43 mils (41.73 mm), an average width of 5.30 mils (13.46 mm), an average cell wall thickness of 0.84 mils (2.13 mm), and average aspect ratio of 3.10.

Moreover, formation of wrinkled insulative cellular polypropylene-based material was found to occur when the exit angle of curvature increased from 44° to 90° as suggested by Example 1, FIGS. 5-7. Based on these results, it may be concluded that die exit angles from enclosed die volumes create different material morphology, with differing resistance to wrinkling and/or creasing, when recipe and process conditions are held constant. In one exemplary embodiment, wrinkle-resistant insulative cellular polypropylene-based material may be created concomitantly with a decrease in die exit angle. The lower the angle of die exit, the easier it is to control and orient the cell aspect ratio, thus enabling preparation of a sheet of insulative cellular polypropylene-based material that possesses cell aspect ratios close to 1.

In exemplary embodiments, die exit angles within an inclusive range of 50°-60° may produce wrinkle-resistant insulative cellular polypropylene-based material. In other exemplary embodiments, die exit angles within an inclusive range of 40°-50° may produce wrinkle-resistant insulative cellular polypropylene-based material. In other exemplary embodiments, die exit angles within an inclusive range of 30°-40° may produce wrinkle-resistant insulative cellular polypropylene-based material. In other exemplary embodiments, die exit angles within an inclusive range of 20°-30° may produce wrinkle-resistant insulative cellular polypropylene-based material. In other exemplary embodiments, die exit angles within an inclusive range of 10°-20° may produce wrinkle-resistant insulative cellular polypropylene-based material. In other exemplary embodiments, die exit angles within an inclusive range of 0°-10° may produce wrinkle-resistant insulative cellular polypropylene-based material. The higher the angle of die exit, the more oriented the cell aspect ratio becomes, especially in the direction parallel to the flow of insulative cellular polypropylene-based material. Without wishing to be bound by theory, lower cell aspect ratios may reduce local stress concentrations that are experienced during convolution of insulative cellular polypropylene-based material, thus leading to wrinkle-resistant and/or crease-resistant material.

TABLE 1
Circumferential Direction and Axial Direction Dimensional
Attributes of Material C and Material D

| | | 44° | 90° |
|---|---|---|---|
| | Cells dimensions | Material | Material |
| | [milli inches] | C | D |
| Circumferential | Cell length | 19.54 | 17.01 |
| Direction | Cell width | 8.53 | 5.22 |
| | Circumferential | 2.29 | 3.26 |
| | Direction Cell Aspect | | |
| | Ratio | | |
| | Cell Wall Thickness | 1.02 | 0.77 |
| Axial Direction | Cell length | 18.45 | 16.43 |
| | Cell width | 8.28 | 5.30 |
| | Axial Direction Cell | 2.23 | 3.10 |
| | Aspect Ratio | | |
| | Cell Wall Thickness | 0.96 | 0.84 |

### Example 2

### Formulation, Extrusion, and Sheet Formation

High resolution microscopy may be used to determine the dimensional properties of insulative cellular non-aromatic polymeric materials. The Keyence VHX-1000 Digital Microscope and Keyence VHX-2000 Digital Microscope were used to determine the dimensional properties of insulative cellular polypropylene-based material cells from the present disclosure.

Nine specified formulations with dissimilar processing conditions as shown in Table 2 produced cell dimensional properties that were found to follow a power law model with high accuracy and produce material that may possess wrinkle resistance. The following variables were held constant throughout iterations 1-18: 1° extruder temperature, 2° temperature, extruder speed, sheet pull rate, cooling mandrel diameter, cooling mandrel temperature, and overall die temperature as shown in Table 3A. The following variables were altered throughout the aforementioned trial iterations: formula, exit die pressure, die lip angle, die air ring cooling [1/min], and orientation as shown in Table 3A. The following variables were held constant throughout iterations 19-45: 1° extruder temperature, extruder speed, sheet pull rate, cooling mandrel diameter, cooling mandrel temperature, and overall die temperature as shown in Table 3B. The following variables were altered throughout the aforementioned trial iterations: 2° temperature, exit die pressure, die air ring cooling [1/min], CO₂%, and orientation as shown in Table 3B. Iterations 46-50 were conducted in a manner similar to iterations 1-45 in order to investigate the occurrence of creasing during convolution of insulative cellular polypropylene-based material into a circular article (see, Table 3C).

Axial direction and circumferential direction dimensional attributes of 50 different iterations with nine specified formulations were incorporated in the analysis in order to produce data sufficient for high accuracy and precision, as shown in FIGS. 5-7. The specific formulation described above for Example 1 as well as eight other formulations were used to illustrate this aspect of the present disclosure as shown in Table 2.

TABLE 2
Formulations and Processing Conditions

| | | | Chemical | | | | | CO₂ |
|---|---|---|---|---|---|---|---|---|
| Formula | | | Blowing | Additive | Additive | Additive | Additive | (Lbs/Hr) |
| # | 1° Resin | 2° Resin | Agent | #1 | #2 | #3 | #4 | [Table 3B] |
| 1 | 81.5% Borealis | 15% Braskem | None | 0.5% Heritage | 1% Colortech | 2% Ampacet ™ | None | 2.2-2.3 |
| | WB140 HMS | F020HC | | Plastics HT4HP | 11933-19 | 102823 | | |
| | | | | Talc | TiO₂-PP | Process Aid | | |
| 2 | 82.5% Borealis | 15% Braskem | None | 0.5% Techmer | None | 2% Ampacet ™ | None | 2.2-2.3 |
| | WB140 HMS | F020HC | | PM PPM16466 | | 102823 | | |
| | | | | Silica | | Process Aid | | |
| 3 | 82.5% Borealis | 15% Braskem | None | 0.5% Techmer | None | 2% Ampacet ™ | None | 2.2-2.3 |
| | WB140 HMS | F020HC | | PM PPM16464 | | 102823 | | |
| | | | | Silica | | Process Aid | | |
| 4 | 82.5% Borealis | 15% Braskem | None | 0.5% Heritage | None | 2% Ampacet ™ | None | 2.2-2.3 |
| | WB140 HMS | F020HC | | Plastics HT4HP | | 102823 | | |
| | | | | Talc | | Process Aid | | |
| 5 | 81.5% Borealis | 15% Braskem | None | 0.5% Heritage | 1% Cell | 2% Ampacet ™ | None | 2.2-2.3 |
| | WB140 HMS | F020HC | | Plastics HT4HP | Stabilizer | 102823 | | |
| | | | | Talc | | Process Aid | | |
| 6 | 81.45% Borealis | 15% Braskem | 0.05% Clariant | 0.5% Heritage | 1% Colortech | 2% Ampacet ™ | None | 2.2-2.4 |
| | WB140 HMS | F020HC | Hydrocerol | Plastics HT4HP | 11933-19 | 102823 | | |
| | | | CF-40E ™ | Talc | TiO₂-PP | Process Aid | | |
| 7 | 81.45% Borealis | 15% Braskem | 0.05% Clariant | 0.5% Techmer | 1% Colortech | 2% Ampacet ™ | None | 2.2-2.4 |
| | WB140 HMS | F020HC | Hydrocerol | PM PPM16466 | 11933-19 | 102823 | | |
| | | | CF-40E ™ | Silica | TiO₂-PP | Process Aid | | |
| 8 | 79.95% Borealis | 15% Braskem | 0.05% Clariant | 2% Heritage | 1% Colortech | 2% Ampacet ™ | None | 2.8 |
| | WB140 HMS | F020HC | Hydrocerol | Plastics HT4HP | 11933-19 | 102823 | | |
| | | | CF-40E ™ | Talc | TiO₂-PP | Process Aid | | |
| 9 | 77.95% Borealis | 15% Braskem | 0.05% Clariant | 2% Heritage | 1% Colortech | 2% Ampacet ™ | 2% Techmer | 2.8 |
| | WB140 HMS | F020HC | Hydrocerol | Plastics HT4HP | 11933-19 | 102823 | PM PPM16466 | |
| | | | CF-40E ™ | Talc | TiO₂-PP | Process Aid | Silica | |

TABLE 3A
Trial Iterations

| Iteration | Formula | Orientation | |
|---|---|---|---|
| # | # | # | Wrinkle |
| 1 | 8 | Axial Direction | No |
| 2 | 1 | Circumferential | Yes |
| | | Direction | |
| 3 | 9 | Axial Direction | No |
| 4 | 9 | Circumferential | No |
| | | Direction | |
| 5 | 6 | Axial Direction | Yes |
| 6 | 6 | Circumferential | Yes |
| | | Direction | |
| 7 | 6 | Axial Direction | No |
| 8 | 6 | Circumferential | No |
| | | Direction | |
| 9 | 7 | Axial Direction | No |
| 10 | 7 | Circumferential | No |
| | | Direction | |
| 11 | 3 | Circumferential | Yes |
| | | Direction | |
| 12 | 3 | Circumferential | Yes |
| | | Direction | |
| 13 | 2 | Circumferential | Yes |
| | | Direction | |
| 14 | 2 | Circumferential | Yes |
| | | Direction | |
| 15 | 4 | Circumferential | Yes |
| | | Direction | |
| 16 | 4 | Circumferential | Yes |
| | | Direction | |
| 17 | 5 | Circumferential | Yes |
| | | Direction | |
| 18 | 5 | Circumferential | Yes |
| | | Direction | |

TABLE 3B
Trial Iterations (continued)

| | | Secondary | | | |
|---|---|---|---|---|---|
| Iteration | Formula | Extruder | | | |
| # | # | Temp | CO2 % | Orientation | Wrinkle |
| 19 | 1 | 335 | 2.2 | Axial Direction | No |
| 20 | 1 | 335 | 2.2 | Axial Direction | No |
| 21 | 1 | 335 | 2.2 | Axial Direction | No |
| 22 | 1 | 335 | 2.2 | Axial Direction | No |
| 23 | 1 | 335 | 2.2 | Axial Direction | No |
| 24 | 1 | 330 | 2.2 | Axial Direction | Yes |
| 25 | 1 | 330 | 2.2 | Circumferential | Yes |
| | | | | Direction | |
| 26 | 1 | 330 | 2.2 | Circumferential | No |
| | | | | Direction | |
| 27 | 1 | 330 | 2.2 | Axial Direction | No |
| 28 | 1 | 330 | 2.2 | Circumferential | No |
| | | | | Direction | |
| 29 | 1 | 330 | 2.6 | Axial Direction | Yes |
| 30 | 1 | 330 | 2.6 | Circumferential | Yes |
| | | | | Direction | |
| 31 | 1 | 330 | 2.6 | Axial Direction | No |
| 32 | 1 | 330 | 2.6 | Circumferential | No |
| | | | | Direction | |
| 33 | 1 | 350 | 2.2 | Axial Direction | Yes |
| 34 | 1 | 350 | 2.2 | Circumferential | Yes |
| | | | | Direction | |
| 35 | 1 | 350 | 2.2 | Axial Direction | No |
| 36 | 1 | 350 | 2.2 | Circumferential | No |
| | | | | Direction | |
| 37 | 1 | 350 | 2.2 | Circumferential | No |
| | | | | Direction | |
| 38 | 1 | 350 | 2.2 | Circumferential | No |
| | | | | Direction | |
| 39 | 1 | 350 | 2.2 | Circumferential | No |
| | | | | Direction | |
| 40 | 1 | 350 | 2.2 | Axial Direction | Yes |
| 41 | 1 | 350 | 2.2 | Axial Direction | Yes |
| 42 | 1 | 350 | 2.6 | Axial Direction | Yes |
| 43 | 1 | 350 | 2.6 | Circumferential | Yes |
| | | | | Direction | |
| 44 | 1 | 350 | 2.2 | Axial Direction | No |
| 45 | 1 | 350 | 2.2 | Circumferential | No |
| | | | | Direction | |

TABLE 3C
Trial Iterations (continued)

| Iteration | Formula | Orientation | Wrinkle |
|---|---|---|---|
| 46 | 1 | Circumferential | No |
| | | Direction | |
| 47 | 1 | Circumferential | No |
| | | Direction | |
| 48 | 1 | Circumferential | Yes |
| | | Direction | |
| 49 | 1 | Axial Direction | Yes |
| 50 | 1 | Circumferential | No |
| | | Direction | |

### Example 2

### Test Method

The typical testing method used for cell morphology measurement was as follows:
1.) Cut a side wall blank for an insulative cup as shown in FIG. 4 from a strip of insulative cellular polypropylene-based material as suggested by FIG. 3 or at any other orientation.
2.) Make an insulative cup using the side wall blank by the method disclosed in U.S. patent application Ser. No. 13/526,454 filed on Jun. 18, 2004, disclosure of which is hereby incorporated by reference herein in its entirety.
3.) Cut a strip of the side wall of the insulative cup along the axial direction and circumferential direction.
4.) Hold the material with a flat clamp and use a razor blade to perform a fine shave.
5.) Focus the microscope at 100× and adjust lighting onto the material.
6.) Perform length and width measurements of each unique cell in the axial direction and circumferential direction orientation and record values as suggested by FIG. 5.
7.) Count the number of measured unique cells and record the values as suggested by FIG. 5.
8.) Perform cell wall thickness measurements across 3-4 tangent lines to overall length of each unique cell in the axial direction and circumferential orientation and record the values as suggested by FIG. 6.
9.) Perform three overall strip thickness measurements starting from the bottom of the first measured cell group, to the middle of the cell group, to the top of the cell group as suggested by FIG. 7.
10.) Perform an overall length measurement starting from the lowest complete cell to the highest complete cell as suggested by FIG. 7.
11.) Move microscope visual field so the bottom of the most upper incomplete cell is touching the bottom of the screen.
12.) Repeat steps 6-11 on each new unique cell until about 0.200″ to 0.800″ of the strip is measured. Ensure that the overall length and cell composition does not overlap. Each overall length measurement after the first measurement is taken from the top of the previous highest complete cell to the top of the current highest complete cell.

A sheet of insulative cellular polypropylene-based material produced as described herein typically possessed a density of about 0.1615 g/cm³ and material thickness of about 0.066 inches (1.6764 mm).

### Example 2

### Test Analysis

All cell measurements were performed on over 7500 unique cell units from 50 different samples produced in various ways as described above. Although the maximum window view range of the Keyence digital microscope was 100 mils by 100 mils, careful attention was paid to ensure that each cell was unique and that the overall height and width of the measured strip was an average of values. A total of six (6) different dimensional parameters were measured for iterations 1-18.

In one exemplary embodiment, dimensional parameters of overall strip length (L), overall strip thickness (T), and total numbers of cells in the measured strip area (n) may be classified as bulk properties because they describe an overall cell property. In another exemplary embodiment, dimensional parameters of cell length (1), cell width (w), and cell wall thickness (t) may be classified as cell properties because they describe each cell unit.

A total of five (5) different dimensional parameters were measured for iterations 19-50. In one exemplary embodiment, dimensional parameters of overall strip length (L), overall strip thickness (T), and total numbers of cells in the measured strip area (n) may be classified as bulk properties because they describe an overall cell property. In another exemplary embodiment, dimensional parameters of cell length (1) and cell width (w) may be classified as cell properties because they describe each cell unit.

Each set of dimensional values was separately analyzed to ascertain a correlation between bulk properties and cell properties. Cell density (p) was used to normalize each cell number value because each of the 50 iterations possessed a different number of cells per area (cells/m²) due to different strip geometries. Cell density is calculated as the total number of cells in a given strip (n) divided by the overall strip length (L) and overall strip thickness (T), raised to the 3/2 power, as shown in Equation 1. Cell aspect ratio (A) is calculated as the average cell length (1) divided by the average cell width (w) of given iterations, as shown in Equation 2.

p=(n/TL)^{3/2} Equation 1

A=(l/w) Equation 2

Equation 1 transforms the units from cells per unit area (cells/in²) into cells per unit volume (cells/in³). Through mathematical manipulation of the denominator, the area (m²) is raised to the 3/2 power to transform the dimensional property into volume with correct units (m³). The same correlative effect is applied to the number of cells for consistency. Therefore, cell density is independently measured and calculated from the average bulk properties, as shown in Table 4 and Table 5. Cell properties such as cell length, cell width, and cell wall thickness are also independently measured and the average is calculated, also as shown in Table 4 and Table 5. By comparing independent values, quantitative correlations may be established to predict the occurrence of wrinkle-resistant material based solely on comparison of independent variables.

TABLE 4
Test Analysis Data From Iterations 1-18

| | Number of Cells | Strip | Strip | Cell | Cell | Cell | Cell Wall | Cell |
|---|---|---|---|---|---|---|---|---|
| Iteration | in Strip | Length | Thickness | Density | Length | Width | Thickness | Aspect |
| # | (cells) | (mils) | (mils) | (cells/in³) | (Mils) | (Mils) | (Mils) | Ratio |
| 1 | 265 | 654.48 | 59.05 | 5.68 × 10⁵ | 14.22 | 7.33 | 0.96 | 1.94 |
| 2 | 101 | 521.43 | 84.41 | 1.10 × 10⁵ | 34.28 | 10.87 | 1.83 | 3.15 |
| 3 | 398 | 693.10 | 60.79 | 9.18 × 10⁵ | 11.94 | 6.70 | 0.78 | 1.78 |
| 4 | 290 | 635.96 | 68.79 | 5.40 × 10⁵ | 19.78 | 6.56 | 0.93 | 3.02 |
| 5 | 500 | 759.73 | 70.83 | 8.96 × 10⁵ | 16.43 | 5.30 | 0.84 | 3.10 |
| 6 | 457 | 692.33 | 69.96 | 9.16 × 10⁵ | 17.01 | 5.22 | 0.77 | 3.26 |
| 7 | 281 | 752.03 | 66.41 | 4.22 × 10⁵ | 18.45 | 8.28 | 0.96 | 2.23 |
| 8 | 276 | 754.69 | 69.28 | 3.84 × 10⁵ | 19.54 | 8.53 | 1.02 | 2.29 |
| 9 | 402 | 833.86 | 62.49 | 6.78 × 10⁵ | 8.09 | 5.92 | 0.88 | 1.37 |
| 10 | 421 | 833.37 | 70.72 | 6.04 × 10⁵ | 9.99 | 6.17 | 0.9 | 1.62 |
| 11 | 39 | 828.50 | 50.75 | 2.82 × 10⁴ | 60.77 | 14.81 | 2.40 | 4.10 |
| 12 | 53 | 807.00 | 55.43 | 4.08 × 10⁴ | 51.27 | 12.85 | 2.75 | 3.99 |
| 13 | 37 | 931.48 | 55.28 | 2.28 × 10⁴ | 68.52 | 16.36 | 2.27 | 4.19 |
| 14 | 29 | 802.19 | 58.33 | 1.54 × 10⁴ | 70.44 | 20.80 | 3.12 | 3.39 |
| 15 | 21 | 817.08 | 64.75 | 7.91 × 10³ | 86.75 | 24.36 | 3.43 | 3.56 |
| 16 | 36 | 830.59 | 77.76 | 1.32 × 10⁴ | 65.06 | 19.97 | 2.63 | 3.26 |
| 17 | 31 | 825.61 | 64.22 | 1.41 × 10⁴ | 65.00 | 22.00 | 2.99 | 2.95 |
| 18 | 28 | 832.65 | 61.00 | 1.29 × 10⁴ | 63.30 | 20.71 | 3.56 | 3.06 |

TABLE 5
Test Analysis Data from Iterations 19-50

| | | | | Cell |
|---|---|---|---|---|
| Iteration | Cell | Cell | Cell | Aspect |
| # | Length | Width | Density | Ratio |
| 19 | 14.73 | 5.60 | 6.007E+05 | 2.63 |
| 20 | 20.72 | 7.16 | 4.407E+05 | 2.89 |
| 21 | 22.04 | 5.92 | 4.791E+05 | 3.72 |
| 22 | 17.95 | 5.95 | 6.545E+05 | 3.02 |
| 23 | 18.41 | 6.20 | 5.602E+05 | 2.97 |
| 24 | 17.02 | 5.93 | 910587 | 2.87 |
| 25 | 17.48 | 5.29 | 971383 | 3.30 |
| 26 | 13.04 | 5.92 | 1230737 | 2.20 |
| 27 | 13.97 | 6.34 | 1260693 | 2.20 |
| 28 | 13.08 | 6.6 | 1420564 | 1.98 |
| 29 | 18.1 | 5.45 | 1099014 | 3.32 |
| 30 | 20.74 | 6.53 | 728556 | 3.18 |
| 31 | 13.2 | 6.45 | 1167341 | 2.05 |
| 32 | 11.72 | 5.87 | 1851158 | 2.00 |
| 33 | 16.08 | 5.48 | 1179837 | 2.93 |
| 34 | 25.03 | 6.35 | 683270 | 3.94 |
| 35 | 14.02 | 6.05 | 1215786 | 2.32 |
| 36 | 11.54 | 5.94 | 1544317 | 1.94 |
| 37 | 10.59 | 5.46 | 1630729 | 1.94 |
| 38 | 10.71 | 5.52 | 1650454 | 1.94 |
| 39 | 10.78 | 6.1 | 1713915 | 1.77 |
| 40 | 16.14 | 5.43 | 1061618 | 2.97 |
| 41 | 19 | 5 | 911612 | 3.80 |
| 42 | 17.07 | 5.26 | 1159422 | 3.25 |
| 43 | 20.36 | 5.61 | 933041 | 3.63 |
| 44 | 14.81 | 6.51 | 1006006 | 2.27 |
| 45 | 12.57 | 6.05 | 1405602 | 2.08 |
| 46 | 12.99 | 6.38 | 1345104 | 2.04 |
| 47 | 13.5 | 6.03 | 1355593 | 2.24 |
| 48 | 21.82 | 6.69 | 751112.4 | 3.26 |
| 49 | 15.74 | 5.24 | 1005240 | 3.00 |
| 50 | 11.07 | 5.31 | 1962021 | 2.08 |

### Example 2

### Test Results

By correlating cell density bulk property to cell length, cell width, and cell wall thickness cell properties, a strong correlation was found that may predict dimensional properties with respect to cell density, and subsequently cell area. The coefficient of determination (R²) values produced by Microsoft Excel 2010 power law regression fit demonstrates a high degree of accuracy with regard to the validity of the fitted power law-based model. The power law has an equation form of two dependent variables, x and y, and two independent variables or constants, A and K, as shown in Equation 3 and Equation 4:

y=Ax^{K} Equation 3

x=(y/A)^{l/K} Equation 4

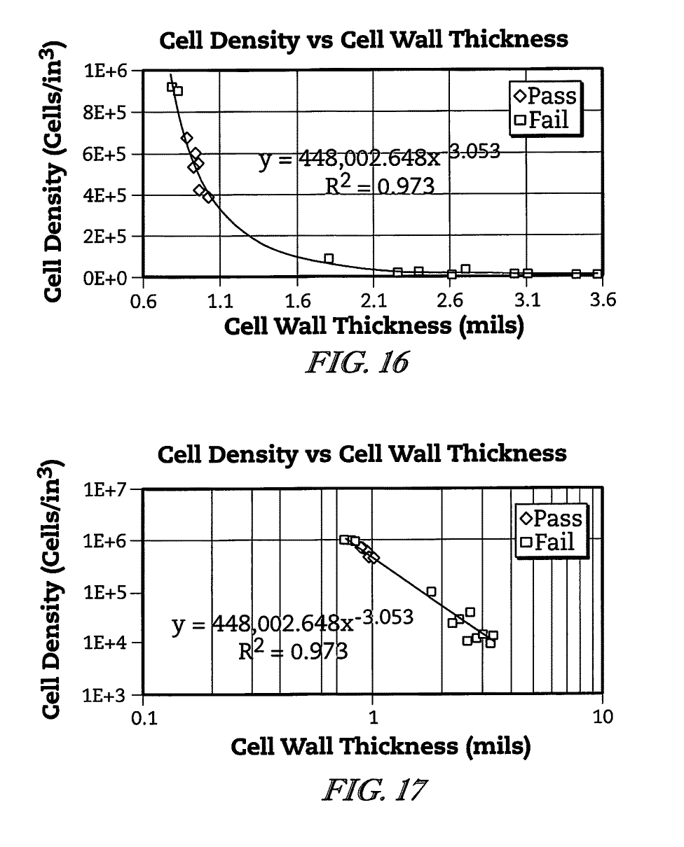

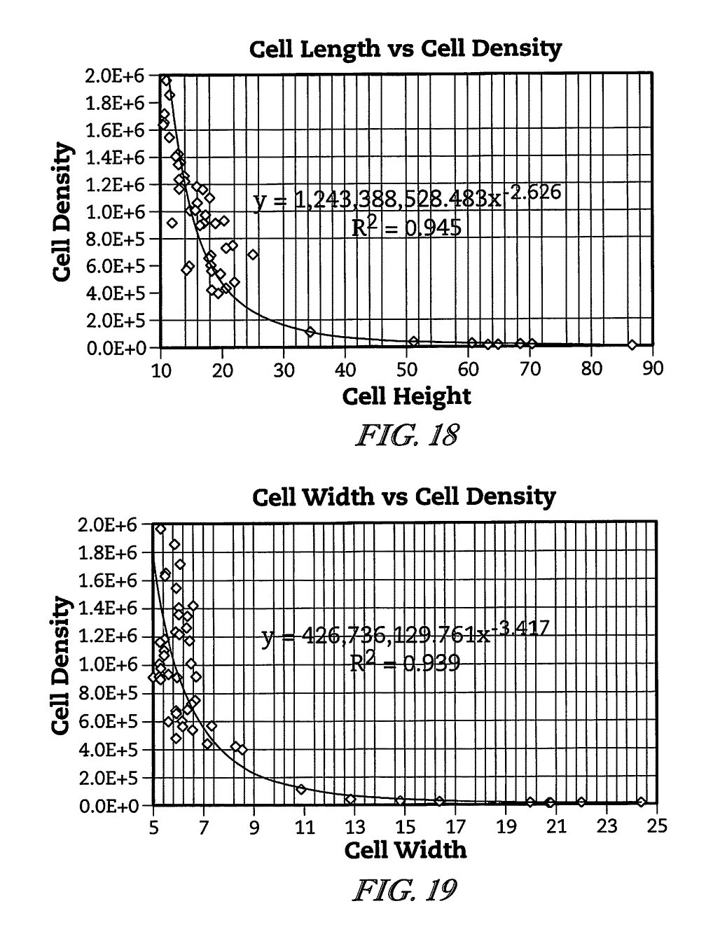

In exemplary embodiments, cell density may predict cell length, cell width, and cell wall thickness with R² values of 0.945, 0.939, and 0.973 as shown in FIG. 18, FIG. 19 and FIG. 16, respectively. The closer the R² value is to 1, the more accurate the model fit. It is generally accepted that a regression fit value greater than 0.85 demonstrates a strong quantitative correlation between two independent variables, which, in this case, are represented by bulk properties and cell properties.

In exemplary embodiments, the equation for predicting cell length with respect to cell density may be y=1,243,388,528.483x^{-2.626}, wherein the power law constants for predicting cell length with respect to cell density are A=1,243,388,528.483 and K=−2.626. In other exemplary embodiments, the equation for predicting cell width with respect to cell density may be y=426,736,129.761x^{-3.417} wherein the power law constants for predicting cell width with respect to cell density are A=426,736,129.761 and K=−3.417. In other exemplary embodiments, the equation for predicting cell wall thickness with respect to cell density may be y=448,002.648x^{-3.653} wherein the power law constants for predicting cell wall thickness with respect to cell density are A=448,002.648 and K=−3.053.

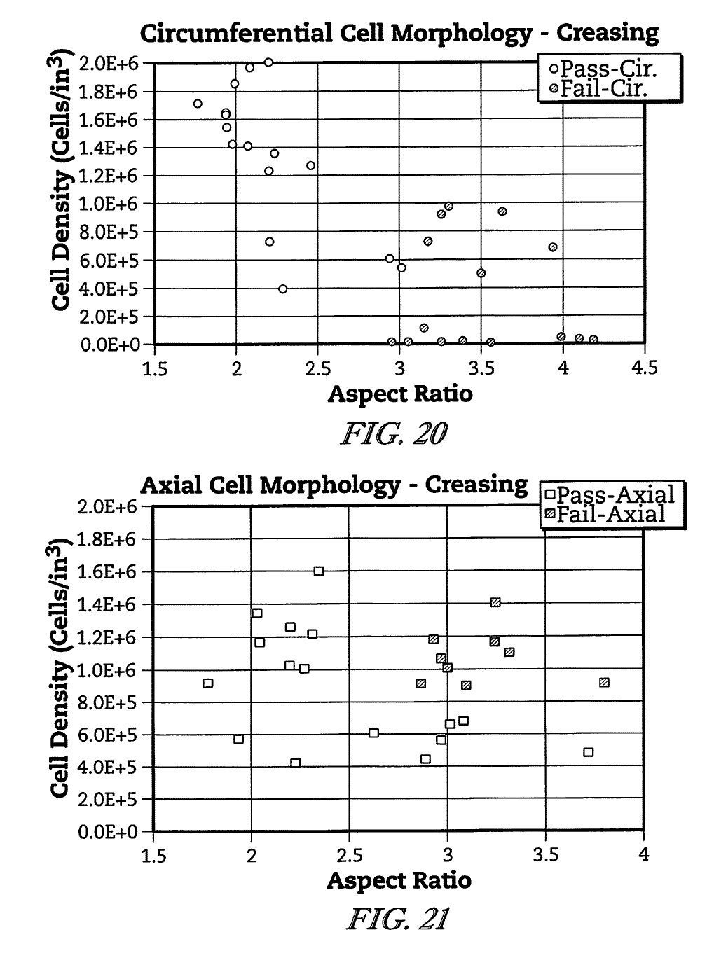

The data also illustrate a satisfactory range where insulative cellular polypropylene-based material possesses wrinkle resistance or lacks wrinkles altogether, as defined by Pass and Fail, where Pass means wrinkles and/or creases are not present and Fails means wrinkles and/or creases are present. As shown in FIG. 20 and FIG. 21, the data may be organized in both the circumferential direction and axial direction. From interpretation of the data in FIG. 20, it may be seen that the aspect ratio of cells that run parallel to the circumference (i.e., in the circumferential direction) may not only play an important role in determining wrinkle resistance, but a more important role than that of either cell density or the aspect ratio of cells running perpendicular to the circumference (i.e., in the axial direction, as shown in FIG. 21).

In exemplary embodiments as suggested by FIG. 20, insulative cellular polypropylene-based material that possesses a cell aspect ratio of less than about 2.75 in the circumferential direction of an article, such as an insulative cup, may not wrinkle when convoluted into the article. Illustratively, insulative cellular polypropylene-based material that possesses a cell aspect ratio of 2.5 or less in the circumferential direction of an article, such as an insulative cup, may not wrinkle when convoluted into the article. In other exemplary embodiments as suggested by FIG. 21, insulative cellular polypropylene-based material that possesses a cell aspect ratio of less than about 2.75 in the axial direction of an article, such as an insulative cup, may not wrinkle when convoluted into the article. Illustratively, insulative cellular polypropylene-based material that possesses a cell aspect ratio of 2.5 or less in the axial direction of an article, such as an insulative cup, may not wrinkle when convoluted into the article. In other exemplary embodiments as suggested by FIG. 21, insulative cellular polypropylene-based material that possesses a cell aspect ratio of about 2.75 to about 4.00 in the axial direction of an article, such as an insulative cup, and a cell density of about 300,000 cells/in³ to about 900,000 cells/in³ may not wrinkle when convoluted into the article. In other exemplary embodiments as suggested by FIG. 20, insulative cellular polypropylene-based material that possesses a cell aspect ratio of about 2.75 to about 3.5 in the circumferential direction of an article, such as an insulative cup, and a cell density of about 300,000 cells/in³ to about 700,000 cells/in³ may not wrinkle when convoluted into the article.

The cell prediction model accurately describes cell growth in the cell width, cell length, and cell wall thickness category and possesses power law functionality, similarly to that seen in many natural phenomena. By taking on a log-log plot form, the correlation is unexpectedly a straight line that penetrates near or through all data points with accuracy. This development provides further evidence for power law correlation and subsequently the ability to model and predict cell growth, as shown in FIGS. 12-17.

As presaged by the wrinkle-resistant versus micro-creasing/macro-creasing results shown in FIG. 12-15, and as summarily illustrated in FIG. 20 and FIG. 21, the present disclosure permits the identification of a control range with respect to cell aspect ratio and cell density, which range permits the manufacture of insulative cups that do not wrinkle and/or crease. FIG. 20 illustrates cell densities in a (cup) convolution process as a function of cell aspect ratio in the circumferential direction, whereas FIG. 21 illustrates cell densities in a (cup) convolution process as a function of cell aspect ratio in the axial direction. In FIG. 20 and FIG. 21, cell densities that Pass are tolerated without the onset of wrinkling and/or creasing during cup convolution. Conversely, cell densities in FIG. 20 and FIG. 21 that are associated with wrinkling and/or creasing during cup convolution, i.e., that Fail, result in micro-creasing and/or macro-creasing, where micro-creasing and/or macro-creasing are defined as follows:

Micro-Creasing defines small creases inside the cup found in the middle, top, and especially bottom areas; they are generally ¼″ to ½″ in length and near invisible to the eye unless you look for them.

Macro-Creasing defines large creases inside the cup that run all the way from the bottom to top or tangent to the cup; they are generally cup-length and very visible to the eye.

1. An insulative cellular polypropylene-based material comprising
a first polymer material comprising at least one high melt strength polypropylene homopolymer and
a second polymer material comprising at least one polymer selected from the group consisting of crystalline polypropylene homopolymer, impact polypropylene copolymer, and mixtures thereof,
wherein the material is wrinkle-resistant or crease resistant.

2. The insulative cellular polypropylene-based material of claim 1, further comprising at least one nucleating agent.

3. The insulative cellular polypropylene-based material of claim 1, further comprising at least one slip agent.

4. The insulative cellular polypropylene-based material of claim 1 having a cell aspect ratio in a circumferential direction of less than about 2.75.

5. The insulative cellular polypropylene-based material of claim 4 having a cell aspect ratio in the circumferential direction of less than about 2.5.

6. The insulative cellular polypropylene-based material of claim 1 having a cell aspect ratio in an axial direction of less than about 2.75.

7. The insulative cellular polypropylene-based material of claim 6 having a cell aspect ratio in the axial direction of less than about 2.5.

8. The insulative cellular polypropylene-based material of claim 7 having a cell aspect ratio in the circumferential direction of less than about 3.5.

9. The insulative cellular polypropylene-based material of claim 8 having a cell aspect ratio in the circumferential direction of less than about 3.25.

10. The insulative cellular polypropylene-based material of claim 9 having a cell aspect ratio in the circumferential direction of less than about 3.0.

11. The insulative cellular polypropylene-based material of claim 10 having a cell aspect ratio in the circumferential direction of less than about 2.75.

12. The insulative cellular polypropylene-based material of claim 11 having a cell aspect ratio in the circumferential direction of less than about 2.5.

13. The insulative cellular polypropylene-based material of claim 6 having a cell aspect ratio in the circumferential direction of less than about 3.5.

14. The insulative cellular polypropylene-based material of claim 13 having a cell aspect ratio in the circumferential direction of less than about 3.25.

15. The insulative cellular polypropylene-based material of claim 14 having a cell aspect ratio in the circumferential direction of less than about 3.0.

16. The insulative cellular polypropylene-based material of claim 15 having a cell aspect ratio in the circumferential direction of less than about 2.75.

17. The insulative cellular polypropylene-based material of claim 16 having a cell aspect ratio in the circumferential direction of less than about 2.5.

18. The insulative cellular polypropylene-based material of claim 1 having a cell aspect ratio in the axial direction of about 2.75 to about 3.75 and a cell density of about 800,000 cells/in³.

19. The insulative cellular polypropylene-based material of claim 1 having a cell density of about 200,000 cells/in³ to about 700,000 cells/in³ and a cell aspect ratio in the circumferential direction of about 2.75 to about 3.5.

20. The insulative cellular polypropylene-based material of claim 1 having a cell density of about 200,000 cells/in³ to about 900,000 cells/in³ and a cell aspect ratio in the axial direction of about 2.75 to about 4.0.

21. The insulative cellular polypropylene-based material of claim 1 having a cell density of about 700,000 cells/in³ to about 2,000,000 cells/in³ and a cell aspect ratio in the circumferential direction of about 2.75 to about 4.5, wherein the material is micro-creasing or macro-creasing.

22. The insulative cellular polypropylene-based material of claim 1 having a cell density of about 900,000 cells/in³ to about 2,000,000 cells/in³ and a cell aspect ratio in the axial direction of about 2.75 to about 4.5, wherein the material is micro-creasing or macro-creasing.

23. The insulative cellular polypropylene-based material of claim 1 having a cell aspect ratio in the circumferential direction greater than 3.5.

24. The insulative cellular polypropylene-based material of claim 1 having a cell density of about 800,000 cells/in³.

25. The insulative cellular polypropylene-based material of claim 1 having a cell density of about 200,000 cells/in³ to about 700,000 cells/in³.

26. The insulative cellular polypropylene-based material of claim 1 having a cell density of about 200,000 cells/in³ to about 900,000 cells/in³.
